(19) United States
(12) Patent Application Publication
(10) Pub. No.: US 2026/0143304 A1
(43) Pub. Date: May 21, 2026

(54) SYSTEM AND METHOD FOR AN OUTDOOR RECREATION SAFETY AND COMMUNICATION SYSTEM

(71) Applicants: Lindsey Molinere, Gray, LA (US); Terry Molinere, Chauvin, LA (US)

(72) Inventors: Lindsey Molinere, Gray, LA (US); Terry Molinere, Chauvin, LA (US)

(21) Appl. No.: 19/397,419

(22) Filed: Nov. 21, 2025

Related U.S. Application Data
(60) Provisional application No. 63/723,537, filed on Nov. 21, 2024.
(60) Provisional application No. 63/740,186, filed on Dec. 30, 2024.

(51) Int. Cl. H04W 4/02; H04M 1/72421; H04M 1/72424; H04M 1/72436; H04W 4/021; H04W 4/90; H04W 84/06

(52) U.S. Cl. CPC H04W 4/023; H04M 1/72421; H04M 1/72424; H04M 1/72436; H04W 4/022; H04W 4/90; H04M 2250/10; H04W 84/06

(57) ABSTRACT

The present disclosure provides a system for enhancing safety and communication among hunters in approved hunting areas, comprising a global positioning system configured to detect and transmit geospatial data, a processor operably connected to the global positioning system, a power supply, and a non-transitory computer-readable medium coupled to the processor. The non-transitory computer-readable medium contains instructions stored thereon, which, when executed by the processor, cause the processor to perform operations comprising receiving the geospatial data transmitted by the global positioning system, determining real-time locations of multiple hunters within the approved hunting areas, establishing a customizable safety radius around each hunter, wherein the safety radius can be manually set or selected from preinstalled modes tailored to specific firearms, monitoring when another hunter enters the customizable safety radius, and sending proximity alerts to both hunters when the safety radius is crossed.

### CROSS-REFERENCE TO RELATED APPLICATION

This application claims the benefit of U.S. Provisional Patent Application Ser. No. 63/723,537 filed Nov. 21, 2024 and of U.S. Provisional Patent Application Ser. No. 63/740,186 filed Dec. 30, 2024, which applications are incorporated herein by reference.

### FIELD OF INVENTION

The present disclosure relates to safety and communication systems for outdoor recreational activities, and more particularly to an integrated GPS-based system that provides real-time location tracking, proximity alerts, emergency response capabilities, and collaborative communication tools for hunters operating in approved hunting areas.

### BACKGROUND

Outdoor recreational activities such as hunting, hiking, and fishing have experienced tremendous growth in participation, with millions of individuals engaging in these pursuits annually across diverse terrains and challenging environments. These activities frequently involve groups of participants operating in remote wilderness areas where conventional communication infrastructure is either severely limited or completely unavailable. The distributed nature of such recreational pursuits, particularly hunting expeditions, requires participants to spread across vast areas to maximize their effectiveness, often resulting in distances of several miles between group members. Environmental factors including dense forest canopies, mountainous terrain, deep valleys, and adverse weather conditions create significant barriers to maintaining visual or auditory contact among participants. Traditional methods of group coordination, such as predetermined meeting points or scheduled check-ins, prove inadequate when dealing with the dynamic and unpredictable nature of outdoor recreational activities. The combination of remote locations, challenging terrain, and the inherent risks associated with activities like hunting creates a compelling need for advanced technological solutions that can bridge these communication and safety gaps.

Contemporary outdoor enthusiasts have increasingly embraced technological solutions to enhance their recreational experiences and address persistent safety concerns that have plagued these activities for decades. Global Positioning System (GPS) technology has achieved widespread adoption for basic navigation and rudimentary location tracking in outdoor recreational contexts, with handheld GPS devices and smartphone applications becoming standard equipment for many participants. Mobile communication devices and specialized outdoor applications have evolved to provide various functionalities including weather forecasting, topographic mapping services, and elementary communication tools designed for outdoor use. However, these existing technological solutions typically operate as standalone systems that fail to integrate seamlessly with one another, creating fragmented user experiences and limiting their overall effectiveness. Many current GPS-based systems provide only basic waypoint navigation and lack the sophisticated real-time tracking capabilities necessary for dynamic group coordination during active recreational pursuits. The proliferation of these disparate technological tools has created a landscape where outdoor enthusiasts must juggle multiple devices and applications, each addressing only a narrow subset of their comprehensive safety and communication needs.

Existing solutions in the outdoor recreation technology marketplace demonstrate significant limitations by addressing individual aspects of safety and communication in isolation rather than providing comprehensive integrated platforms. Many current systems focus predominantly on basic navigation functionality or rudimentary location sharing without incorporating essential safety features such as proximity monitoring, emergency response capabilities, or collaborative communication tools specifically designed for group activities. For example, popular hiking applications may provide trail maps and basic GPS tracking but lack the ability to monitor the relative positions of group members or provide automated alerts when participants venture too far from designated safe zones. Traditional communication methods such as two-way radios, while still widely used, suffer from inherent range limitations that typically restrict effective communication to distances of only a few miles under optimal conditions. These radio-based systems become even less reliable in challenging terrain where hills, valleys, and dense vegetation can dramatically reduce their effective range to mere hundreds of yards. The fragmented nature of current technological offerings forces outdoor enthusiasts to carry multiple devices and rely on various applications simultaneously, creating complexity and potential points of failure when integrated solutions would be far more effective.

The outdoor recreation industry has increasingly recognized the substantial potential for integrated technology solutions that combine multiple safety and communication features into unified, comprehensive platforms capable of addressing the complex challenges faced by modern outdoor enthusiasts. Such integrated systems could potentially revolutionize how participants in activities like hunting expeditions maintain situational awareness, coordinate group movements, and respond to emergency situations in remote environments. Current market analysis indicates a growing demand for solutions that can seamlessly blend real-time location tracking, proximity monitoring, emergency response capabilities, and collaborative communication tools into single, user-friendly platforms. Industry stakeholders have identified key areas where technological integration could provide significant value, including automated safety zone monitoring, instant emergency alert systems, and collaborative information sharing about environmental conditions and wildlife activity. The potential for such systems extends beyond basic safety applications to include enhanced recreational experiences through features like shared mapping, coordinated hunting strategies, and digital documentation of outdoor adventures. However, despite this recognized potential and market demand, existing solutions continue to fall short of delivering truly integrated platforms that can comprehensively address the multifaceted needs of outdoor recreational groups.

Emergency response in remote outdoor environments presents particularly acute challenges due to the combination of limited or nonexistent cellular coverage, difficulty in accurately pinpointing exact locations, and significant delays inherent in summoning professional assistance to remote wilderness areas. Current emergency communication methods employed by outdoor enthusiasts often rely on satellite communication devices that can cost hundreds or thousands of dollars and require specialized knowledge to operate effectively, making them inaccessible to many recreational participants. Even when emergency communication devices are available, they typically provide only basic distress signaling capabilities without the ability to transmit detailed location information, medical condition data, or situational context that could be crucial for effective emergency response. The challenge of location accuracy becomes particularly critical in dense forest environments or mountainous terrain where GPS signals may be degraded or where small differences in coordinates can mean the difference between a successful rescue and a prolonged search operation. Traditional emergency response protocols designed for urban or suburban environments prove inadequate when applied to remote outdoor settings where professional emergency services may be hours away from the nearest access point. Additionally, current systems generally lack the capability to automatically alert other group members or designated emergency contacts when a participant fails to check in or when emergency situations arise, creating dangerous gaps in the safety net that should protect outdoor recreational participants.

### SUMMARY

A system and method for outdoor recreation safety and communication is provided. In one aspect, the system enhances safety and communication among hunters in approved hunting areas through GPS-based real-time location tracking and proximity monitoring. In another aspect, the system allows users to establish customizable safety radii around each hunter based on firearm specifications and activity types. In yet another aspect, the present invention provides emergency response capabilities through an integrated SOS system that transmits location data to nearby hunters and emergency contacts. In still another aspect, the present invention enables collaborative hunting through shared animal location markers and group communication features on an interactive map interface. Generally, the present invention is a system and method for outdoor recreational participants to improve safety coordination and communication in remote wilderness environments.

The system includes a GPS device and processor configured to receive and process geospatial data from multiple hunters. The processor comprises computing capabilities and memory storing instructions that, when executed, cause the processor to perform operations including: receiving geospatial data transmitted by the GPS system; determining real-time locations of multiple hunters within approved hunting areas; establishing customizable safety radii around each hunter; monitoring proximity between hunters; and sending automated alerts when safety boundaries are crossed. The system further comprises at least one computing device with a user interface communicatively coupled to the processor. The computing device is configured to present an interactive map showing real-time hunter locations, safety radii, and animal sighting markers.

The system may include one or more of the following features. The processor may be configured to provide emergency alert capabilities accessible via a centrally located action button that activates SOS functionality. The system may employ customizable boundary areas created by dropping pins along boundary lines with monitoring for approach within predetermined distances. The processor may generate proximity alerts and boundary notifications based on real-time location analysis. The computing device may comprise a mobile application interface allowing direct user control of safety settings and communication features. The system may include group chat functionality for real-time communication between hunters, enabling sharing of text messages and images. Digital logbook capabilities may be provided to allow documentation of hunting experiences with location, date, time, and observations.

The present invention is furthermore a method for managing hunter safety in approved hunting areas. The method includes: determining real-time geolocations of multiple hunters using GPS technology; establishing customizable safety radii around each hunter based on firearm specifications; monitoring proximity between hunters within approved hunting areas; sending automated proximity alerts when hunters enter each other's safety radii; providing emergency response capabilities through an SOS system that transmits location data; and facilitating collaborative hunting through shared animal location markers on an interactive map interface. Preferably, the method may further include implementing check-in features requiring hunters to confirm safety at predetermined intervals, creating customizable boundary areas with monitoring capabilities, and providing group communication functionality. The method may enable real-time location sharing and collaborative information sharing about environmental conditions and wildlife activity.

The foregoing summary has outlined some features of the system and method of the present disclosure so that those skilled in the pertinent art may better understand the detailed description that follows. Additional features that form the subject of the claims will be described hereinafter. Those skilled in the pertinent art should appreciate that they can readily utilize these features for designing or modifying other structures for carrying out the same purpose of the system and method disclosed herein. Those skilled in the pertinent art should also realize that such equivalent designs or modifications do not depart from the scope of the system and method of the present disclosure.

### BRIEF DESCRIPTION OF FIGURES

These and other features, aspects, and advantages of the present disclosure will become better understood with regard to the following description, appended claims, and accompanying drawings where:

FIG. 1 illustrates an environment of the system consisting of clients connected to a server and database via a network, according to aspects of the present disclosure.

FIG. 2 illustrates a block diagram of a computing entity according to an implementation of the system, according to aspects of the present disclosure.

FIG. 3 illustrates a system diagram depicting exemplary computing entities in the form of a computing device and a mobile computing device, according to aspects of the present disclosure.

FIG. 4 illustrates a block diagram of the system for outdoor recreation safety and communication, according to aspects of the present disclosure.

FIG. 5 illustrates a system diagram showing the communication network architecture for emergency alert functionality, according to aspects of the present disclosure.

FIG. 6 illustrates a system diagram showing the check-in timer functionality of the outdoor recreation safety and communication system, according to aspects of the present disclosure.

FIG. 7 illustrates a system diagram depicting a safety radius configuration for multiple users in an outdoor environment, according to aspects of the present disclosure.

FIG. 8 depicts a user interface displaying a profile screen of the mobile application system, according to aspects of the present disclosure.

FIG. 9 depicts a user interface displayed on a mobile computing device showing a social media feed, according to aspects of the present disclosure.

FIG. 10 depicts a user interface displaying a layers menu overlay on a map screen, according to aspects of the present disclosure.

FIG. 11 depicts a user interface displaying a measurements menu on a mobile device screen, according to aspects of the present disclosure.

FIG. 12A illustrates an orthogonal front view of a user interface displayed on a mobile computing device, according to aspects of the present disclosure.

FIG. 12B illustrates an orthogonal front view of a mobile computing device displaying a user interface for the outdoor recreation safety and communication system, according to aspects of the present disclosure.

FIG. 13 illustrates an orthogonal front view of a mobile computing device displaying a user interface having the live button activated, according to aspects of the present disclosure.

FIG. 14 illustrates an orthogonal front view of a mobile computing device displaying a user interface with the SOS feature activated, according to aspects of the present disclosure.

FIG. 15 illustrates a flowchart depicting the permission levels and access control structure of the system, according to aspects of the present disclosure.

### DETAILED DESCRIPTION

In the Summary above and in this Detailed Description, and the claims below, and in the accompanying drawings, reference is made to particular features, including method steps, of the invention. It is to be understood that the disclosure of the invention in this specification includes all possible combinations of such particular features. For instance, where a particular feature is disclosed in the context of a particular aspect or embodiment of the invention, or a particular claim, that feature can also be used, to the extent possible, in combination with/or in the context of other particular aspects of the embodiments of the invention, and in the invention generally.

The term “comprises”, and grammatical equivalents thereof are used herein to mean that other components, steps, etc. are optionally present. For instance, a system “comprising” components A, B, and C can contain only components A, B, and C, or can contain not only components A, B, and C, but also one or more other components. Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility). The term “premises”, and grammatical equivalents thereof are used herein to mean a structure (residential, commercial, gov't, etc.), together with its land and outbuildings, occupied by a resident or business or considered in an official context. As will be evident from the disclosure provided below, the present invention satisfies the need for outdoor recreation safety and communication.

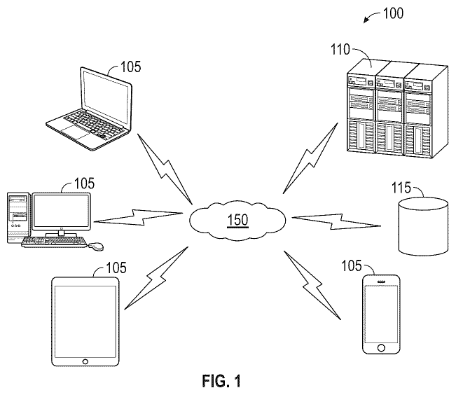

FIG. 1 depicts an exemplary environment 100 of the system 400 consisting of clients 105 connected to a server 110 and/or database 115 via a network 150. Clients 105 are devices of users 405 that may be used to access servers 110 and/or databases 115 through a network 150. A network may comprise of one or more networks of any kind, including, but not limited to, a local area network (LAN), a wide area network (WAN), metropolitan area networks (MAN), a telephone network, such as the Public Switched Telephone Network (PSTN), an intranet, the Internet, a memory device, another type of network, or a combination of networks. In a preferred embodiment, computing entities 200 may act as clients 105 for a user 405. For instance, a client 105 may include a personal computer, a wireless telephone, a streaming device, a “smart” television, a personal digital assistant (PDA), a laptop, a smart phone, a tablet computer, or another type of computation or communication interface 280. Servers 110 may include devices that access, fetch, aggregate, process, search, provide, and/or maintain documents. Although FIG. 1 depicts a preferred embodiment of an environment 100 for the system 400, in other implementations, the environment 100 may contain fewer components, different components, differently arranged components, and/or additional components than those depicted in FIG. 1. Alternatively, or additionally, one or more components of the environment 100 may perform one or more other tasks described as being performed by one or more other components of the environment 100.

As depicted in FIG. 1, one embodiment of the system 400 may comprise a server 110. Although shown as a single server 110 in FIG. 1, a server 110 may, in some implementations, be implemented as multiple devices interlinked together via the network, wherein the devices may be distributed over a large geographic area and performing different functions or similar functions. For instance, two or more servers 110 may be implemented to work as a single server 110 performing the same tasks. Alternatively, one server 110 may perform the functions of multiple servers 110. For instance, a single server 110 may perform the tasks of a web server and an indexing server 110. Additionally, it is understood that multiple servers 110 may be used to operably connect the processor 220 to the database 115 and/or other content repositories. The processor 220 may be operably connected to the server 110 via wired or wireless connection. Types of servers 110 that may be used by the system 400 include, but are not limited to, search servers, document indexing servers, and web servers, or any combination thereof.

Search servers may include one or more computing entities 200 designed to implement a search engine, such as a documents/records search engine, general webpage search engine, etc. Search servers may, for instance, include one or more web servers designed to receive search queries and/or inputs from users 405, search one or more databases 115 in response to the search queries and/or inputs, and provide documents or information, relevant to the search queries and/or inputs, to users 405. In some implementations, search servers may include a web search server that may provide webpages to users 405, wherein a provided webpage may include a reference to a web server at which the desired information and/or links are located. The references to the web server at which the desired information is located may be included in a frame and/or text box, or as a link to the desired information/document. Document indexing servers may include one or more devices designed to index documents available through networks 150. Document indexing servers may access other servers 110, such as web servers that host content, to index the content. In some implementations, document indexing servers may index documents/records stored by other servers 110 connected to the network. Document indexing servers may, for instance, store and index content, information, and documents relating to user accounts and user-generated content. Web servers may include servers 110 that provide webpages to clients 105. For instance, the webpages may be HTML-based webpages. A web server may host one or more websites. As used herein, a website may refer to a collection of related webpages. Frequently, a website may be associated with a single domain name, although some websites may potentially encompass more than one domain name. The concepts described herein may be applied on a per-website basis. Alternatively, in some implementations, the concepts described herein may be applied on a per-webpage basis.

As used herein, a database 115 refers to a set of related data and the way it is organized. Access to this data is usually provided by a database management system (DBMS) consisting of an integrated set of computer software that allows users 405 to interact with one or more databases 115 and provides access to all of the data contained in the database 115. The DBMS provides various functions that allow entry, storage and retrieval of large quantities of information and provides ways to manage how that information is organized. Because of the close relationship between the database 115 and the DBMS, as used herein, the term database 115 refers to both a database 115 and DBMS.

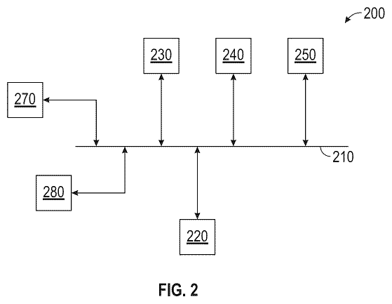

FIG. 2 is an exemplary diagram of a client 105, server 110, and/or or database 115 (hereinafter collectively referred to as “computing entity 200”), which may correspond to one or more of the clients 105, servers 110, and databases 115 according to an implementation consistent with the principles of the invention as described herein. The computing entity 200 may comprise a bus 210, a processor 220, memory 304, a storage device 250, a peripheral device 270, and a communication interface 280 (such as wired or wireless communication device). The bus 210 may be defined as one or more conductors that permit communication among the components of the computing entity 200. The processor 220 may be defined as logic circuitry that responds to and processes the basic instructions that drive the computing entity 200. Memory 304 may be defined as the integrated circuitry that stores information for immediate use in a computing entity 200. A peripheral device 270 may be defined as any hardware used by a user 405 and/or the computing entity 200 to facilitate communicate between the two. A storage device 250 may be defined as a device used to provide mass storage to a computing entity 200. A communication interface 280 may be defined as any transceiver-like device that enables the computing entity 200 to communicate with other devices and/or computing entities 200.

The bus 210 may comprise a high-speed interface 308 and/or a low-speed interface 312 that connects the various components together in a way such they may communicate with one another. A high-speed interface 308 manages bandwidth-intensive operations for computing device 300, while a low-speed interface 312 manages lower bandwidth-intensive operations. In some preferred embodiments, the high-speed interface 308 of a bus 210 may be coupled to the memory 304, display 316, and to high-speed expansion ports 310, which may accept various expansion cards such as a graphics processing unit (GPU). In other preferred embodiments, the low-speed interface 312 of a bus 210 may be coupled to a storage device 250 and low-speed expansion ports 314. The low-speed expansion ports 314 may include various communication ports, such as USB, Bluetooth, Ethernet, wireless Ethernet, etc. Additionally, the low-speed expansion ports 314 may be coupled to one or more peripheral devices 270, such as a keyboard, pointing device, scanner, and/or a networking device, wherein the low-speed expansion ports 314 facilitate the transfer of input data from the peripheral devices 270 to the processor 220 via the low-speed interface 312.

The processor 220 may comprise any type of conventional processor or microprocessor that interprets and executes computer readable instructions. The processor 220 is configured to perform the operations disclosed herein based on instructions stored within the system 400. The processor 220 may process instructions for execution within the computing entity 200, including instructions stored in memory 304 or on a storage device 250, to display graphical information for a graphical user interface (GUI) on an external peripheral device 270, such as a display 316. The processor 220 may provide for coordination of the other components of a computing entity 200, such as control of user interfaces 411, 511, 711, applications run by a computing entity 200, and wireless communication by a communication interface 280 of the computing entity 200. The processor 220 may be any processor or microprocessor suitable for executing instructions. In some embodiments, the processor 220 may have a memory device therein or coupled thereto suitable for storing the data, content, or other information or material disclosed herein. In some instances, the processor 220 may be a component of a larger computing entity 200. A computing entity 200 that may house the processor 220 therein may include, but are not limited to, laptops, desktops, workstations, personal digital assistants, servers 110, mainframes, cellular telephones, tablet computers, smart televisions, streaming devices, or any other similar device. Accordingly, the inventive subject matter disclosed herein, in full or in part, may be implemented or utilized in devices including, but are not limited to, laptops, desktops, workstations, personal digital assistants, servers 110, mainframes, cellular telephones, tablet computers, smart televisions, streaming devices, or any other similar device.

Memory 304 stores information within the computing device 300. In some preferred embodiments, memory 304 may include one or more volatile memory units. In another preferred embodiment, memory 304 may include one or more non-volatile memory units. Memory 304 may also include another form of computer-readable medium, such as a magnetic, solid state, or optical disk. For instance, a portion of a magnetic hard drive may be partitioned as a dynamic scratch space to allow for temporary storage of information that may be used by the processor 220 when faster types of memory, such as random-access memory (RAM), are in high demand. A computer-readable medium may refer to a non-transitory computer-readable memory device. A memory device may refer to storage space within a single storage device 250 or spread across multiple storage devices 250. The memory 304 may comprise main memory 230 and/or read only memory (ROM) 240. In a preferred embodiment, the main memory 230 may comprise RAM or another type of dynamic storage device 250 that stores information and instructions for execution by the processor 220. ROM 240 may comprise a conventional ROM device or another type of static storage device 250 that stores static information and instructions for use by processor 220. The storage device 250 may comprise a magnetic and/or optical recording medium and its corresponding drive.

As mentioned earlier, a peripheral device 270 is a device that facilitates communication between a user 405 and the processor 220. The peripheral device 270 may include, but is not limited to, an input device and/or an output device. As used herein, an input device may be defined as a device that allows a user 405 to input data and instructions that is then converted into a pattern of electrical signals in binary code that are comprehensible to a computing entity 200. An input device of the peripheral device 270 may include one or more conventional devices that permit a user 405 to input information into the computing entity 200, such as a controller, scanner, phone, camera, scanning device, keyboard, a mouse, a pen, voice recognition and/or biometric mechanisms, etc. As used herein, an output device may be defined as a device that translates the electronic signals received from a computing entity 200 into a form intelligible to the user 405. An output device of the peripheral device 270 may include one or more conventional devices that output information to a user 405, including a display 316, a printer, a speaker, an alarm, a projector, etc. Additionally, storage devices 250, such as CD-ROM drives, and other computing entities 200 may act as a peripheral device 270 that may act independently from the operably connected computing entity 200. For instance, a streaming device may transfer data to a smartphone, wherein the smartphone may use that data in a manner separate from the streaming device.

The storage device 250 is capable of providing the computing entity 200 mass storage. In some embodiments, the storage device 250 may comprise a computer-readable medium such as the memory 304, storage device 250, or memory 304 on the processor 220. A computer-readable medium may be defined as one or more physical or logical memory devices and/or carrier waves. Devices that may act as a computer readable medium include, but are not limited to, a hard disk device, optical disk device, tape device, flash memory or other similar solid-state memory device, or an array of devices, including devices in a storage area network or other configurations. Examples of computer-readable mediums include, but are not limited to, magnetic media such as hard disks, floppy disks, and magnetic tape; optical media such as CD ROM discs and DVDs; magneto-optical media such as optical discs; and hardware devices that are specially configured to store and perform programming instructions, such as ROM 240, RAM, flash memory, and the like.

In an embodiment, a computer program may be tangibly embodied in the storage device 250. The computer program may contain instructions that, when executed by the processor 220, performs one or more steps that comprise a method, such as those methods described herein. The instructions within a computer program may be carried to the processor 220 via the bus 210. Alternatively, the computer program may be carried to a computer-readable medium, wherein the information may then be accessed from the computer-readable medium by the processor 220 via the bus 210 as needed. In a preferred embodiment, the software instructions may be read into memory 304 from another computer-readable medium, such as data storage device 250, or from another device via the communication interface 280. Alternatively, hardwired circuitry may be used in place of or in combination with software instructions to implement processes consistent with the principles as described herein. Thus, implementations consistent with the invention as described herein are not limited to any specific combination of hardware circuitry and software.

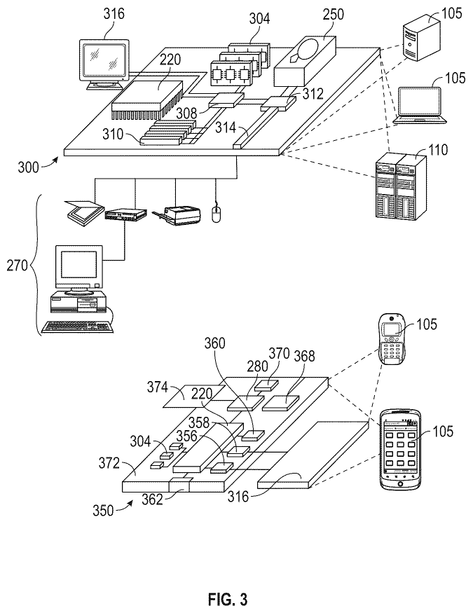

FIG. 3 depicts exemplary computing entities 200 in the form of a computing device 300 and mobile computing device 350, which may be used to carry out the various embodiments of the invention as described herein. A computing device 300 is intended to represent various forms of digital computers, such as laptops, desktops, workstations, servers 110, databases 115, mainframes, and other appropriate computers. A mobile computing device 350 is intended to represent various forms of mobile devices, such as scanners, scanning devices, personal digital assistants, cellular telephones, smart phones, tablet computers, and other similar devices. The various components depicted in FIG. 3, as well as their connections, relationships, and functions are meant to be examples only, and are not meant to limit the implementations of the invention as described herein. The computing device 300 may be implemented in a number of different forms, as shown in FIGS. 1 and 3. For instance, a computing device 300 may be implemented as a server 110 or in a group of servers 110. Computing devices 300 may also be implemented as part of a rack server system. In addition, a computing device 300 may be implemented as a personal computer, such as a desktop computer or laptop computer. Alternatively, components from a computing device 300 may be combined with other components in a mobile device, thus creating a mobile computing device 350. Each mobile computing device 350 may contain one or more computing devices 300 and mobile devices, and an entire system may be made up of multiple computing devices 300 and mobile devices communicating with each other as depicted by the mobile computing device 350 in FIG. 3. The computing entities 200 consistent with the principles of the invention as disclosed herein may perform certain receiving, communicating, generating, output providing, correlating, and storing operations as needed to perform the various methods as described in greater detail below.

In the embodiment depicted in FIG. 3, a computing device 300 may include a processor 220, memory 304 a storage device 250, high-speed expansion ports 310, low-speed expansion ports 314, and bus 210 operably connecting the processor 220, memory 304, storage device 250, high-speed expansion ports 310, and low-speed expansion ports 314. In one preferred embodiment, the bus 210 may comprise a high-speed interface 308 connecting the processor 220 to the memory 304 and high-speed expansion ports 310 as well as a low-speed interface 312 connecting to the low-speed expansion ports 314 and the storage device 250. Because each of the components are interconnected using the bus 210, they may be mounted on a common motherboard as depicted in FIG. 3 or in other manners as appropriate. The processor 220 may process instructions for execution within the computing device 300, including instructions stored in memory 304 or on the storage device 250. Processing these instructions may cause the computing device 300 to display graphical information for a GUI on an output device, such as a display 316 coupled to the high-speed interface 308. In other implementations, multiple processors and/or multiple buses may be used, as appropriate, along with multiple memory units and/or multiple types of memory. Additionally, multiple computing devices may be connected, wherein each device provides portions of the necessary operations.

A mobile computing device 350 may include a processor 220, memory 304 a peripheral device 270 (such as a display 316, a communication interface 280, and a transceiver 368, among other components). A mobile computing device 350 may also be provided with a storage device 250, such as a micro-drive or other previously mentioned storage device 250, to provide additional storage. Preferably, each of the components of the mobile computing device 350 are interconnected using a bus 210, which may allow several of the components of the mobile computing device 350 to be mounted on a common motherboard as depicted in FIG. 3 or in other manners as appropriate. In some implementations, a computer program may be tangibly embodied in an information carrier. The computer program may contain instructions that, when executed by the processor 220, perform one or more methods, such as those described herein. The information carrier is preferably a computer-readable medium, such as memory, expansion memory 374, or memory 304 on the processor 220 such as ROM 240, that may be received via the transceiver or external interface 362. The mobile computing device 350 may be implemented in a number of different forms, as shown in FIG. 3. For instance, a mobile computing device 350 may be implemented as a cellular telephone, part of a smart phone, personal digital assistant, or other similar mobile device.

The processor 220 may execute instructions within the mobile computing device 350, including instructions stored in the memory 304 and/or storage device 250. The processor 220 may be implemented as a chipset of chips that may include separate and multiple analog and/or digital processors. The processor 220 may provide for coordination of the other components of the mobile computing device 350, such as control of the user interfaces 411, 511, 711, applications run by the mobile computing device 350, and wireless communication by the mobile computing device 350. The processor 220 of the mobile computing device 350 may communicate with a user 405 through the control interface 358 coupled to a peripheral device 270 and the display interface 356 coupled to a display 316. The display 316 of the mobile computing device 350 may include, but is not limited to, Liquid Crystal Display (LCD), Light Emitting Diode (LED) display, Organic Light Emitting Diode (OLED) display, and Plasma Display Panel (PDP), holographic displays, augmented reality displays, virtual reality displays, or any combination thereof. The display interface 356 may include appropriate circuitry for causing the display 316 to present graphical and other information to a user 405. The control interface 358 may receive commands from a user 405 via a peripheral device 270 and convert the commands into a computer readable signal for the processor 220. In addition, an external interface 362 may be provided in communication with processor 220, which may enable near area communication of the mobile computing device 350 with other devices. The external interface 362 may provide for wired communications in some implementations or wireless communication in other implementations. In a preferred embodiment, multiple interfaces may be used in a single mobile computing device 350 as is depicted in FIG. 3.

Memory 304 stores information within the mobile computing device 350. Devices that may act as memory 304 for the mobile computing device 350 include, but are not limited to computer-readable media, volatile memory, and non-volatile memory. Expansion memory 374 may also be provided and connected to the mobile computing device 350 through an expansion interface 372, which may include a Single In-Line Memory Module (SIM) card interface or micro secure digital (Micro-SD) card interface. Expansion memory 374 may include, but is not limited to, various types of flash memory and non-volatile random-access memory (NVRAM). Such expansion memory 374 may provide extra storage space for the mobile computing device 350. In addition, expansion memory 374 may store computer programs or other information that may be used by the mobile computing device 350. For instance, expansion memory 374 may have instructions stored thereon that, when carried out by the processor 220, cause the mobile computing device 350 perform the methods described herein. Further, expansion memory 374 may have secure information stored thereon; therefore, expansion memory 374 may be provided as a security module for a mobile computing device 350, wherein the security module may be programmed with instructions that permit secure use of a mobile computing device 350. In addition, expansion memory 374 having secure applications and secure information stored thereon may allow a user 405 to place identifying information on the expansion memory 374 via the mobile computing device 350 in a non-hackable manner.

A mobile computing device 350 may communicate wirelessly through the communication interface 280, which may include digital signal processing circuitry where necessary. The communication interface 280 may provide for communications under various modes or protocols, including, but not limited to, Global System Mobile Communication (GSM), Short Message Services (SMS), Enterprise Messaging System (EMS), Multimedia Messaging Service (MMS), Code Division Multiple Access (CDMA), Time Division Multiple Access (TDMA), Personal Digital Cellular (PDC), Wideband Code Division Multiple Access (WCDMA), IMT Multi-Carrier (CDMAX 0), and General Packet Radio Service (GPRS), or any combination thereof. Such communication may occur, for example, through a transceiver 368. Short-range communication may occur, such as using a Bluetooth, WIFI, or other such transceiver 368. In addition, a Global Positioning System (GPS) receiver module 370 may provide additional navigation-and location-related wireless data to the mobile computing device 350, which may be used as appropriate by applications running on the mobile computing device 350. Alternatively, the mobile computing device 350 may communicate audibly using an audio codec 360, which may receive spoken information from a user 405 and covert the received spoken information into a digital form that may be processed by the processor 220. The audio codec 360 may likewise generate audible sound for a user 405, such as through a speaker, e.g., in a handset of mobile computing device 350. Such sound may include sound from voice telephone calls, recorded sound such as voice messages, music files, etc. Sound may also include sound generated by applications operating on the mobile computing device 350.

The system 400 may comprise a power supply, which may be any source of power that provides the system 400 with the required energy. In a preferred embodiment, the power supply may be a stationary power source that has been installed in a way such that it is fastened in place, such as a 3-prong wall outlet. In a preferred embodiment, the stationary power source is connected to the wiring system of a premises. In another preferred embodiment, the power supply may be a mobile power source, such as a battery pack. In a preferred embodiment, mobile power source does not need to be connected to the wiring system of a premises to provide power to the system but may be capable of connecting to the wiring system of said premises to provide power to a system connected thereto. In another preferred embodiment, the system 400 may comprise multiple power supplies configured to supply power to the system 400 in different circumstances. For instance, the system 400 may be directly plugged into a stationary power source, which may provide power to the system 400 so long as the system does not move out of range of said stationary power source, as well as connected to a mobile power source, which may provide power to the system 400 when the system 400 is not connected to a stationary power source or in situations where the stationary power source ceases to provide power to the system 400.

The system 400 may comprise a power supply, which may be any source of power that provides the system 400 with the required energy. In a preferred embodiment, the power supply may be a stationary power source that has been installed in a way such that it is fastened in place, such as a 3-prong wall outlet. In a preferred embodiment, the stationary power source is connected to the wiring system of a premises, such as a house or a building. In another preferred embodiment, the power supply may be a mobile power source, such as a battery pack, gas-powered generator, and fuel cell. In a preferred embodiment, the mobile power source does not need to be connected to the wiring system of a premises to provide power to the system but may be capable of connecting to the wiring system of said premises to provide power to a system connected thereto. In another preferred embodiment, the system 400 may comprise multiple power supplies configured to supply power to the system 400 in different circumstances. For instance, the system 400 may be directly plugged into a stationary power source, which may provide power to the system 400 so long as the system does not move out of range of said stationary power source, as well as connected to a mobile power source, which may provide power to the system 400 when the system 400 is not connected to a stationary power source or in situations where the stationary power source ceases to provide power to the system 400. In yet another preferred embodiment, a plurality of solar charging panels may be operably connected to a battery of the system, which may then supply power to the system either directly or via the wiring of the premises. As such, the system 400 may be configured to receive power in a variety of ways without departing from the inventive subject matter described herein.

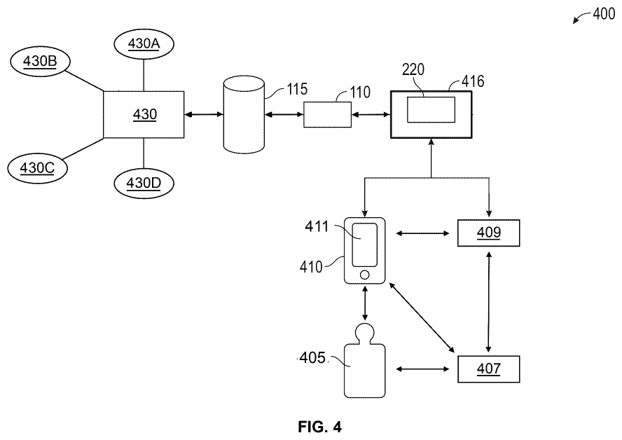

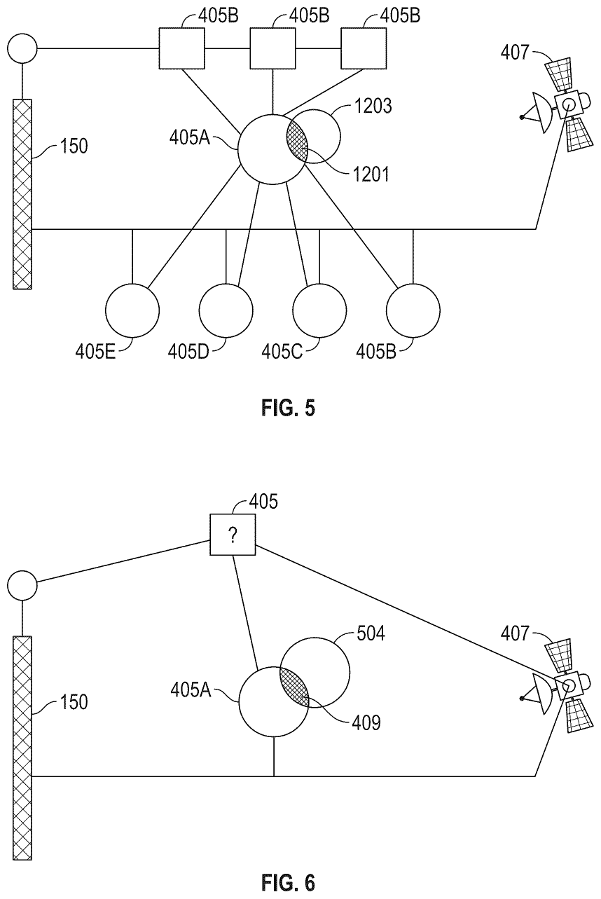

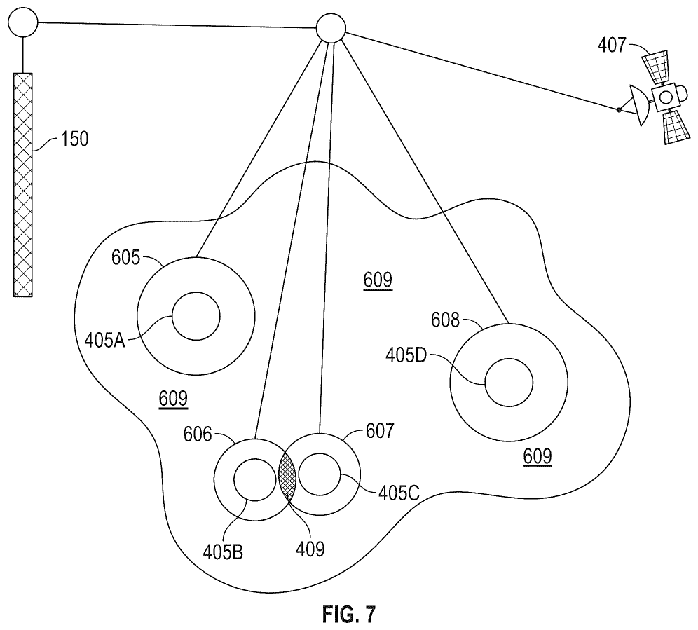

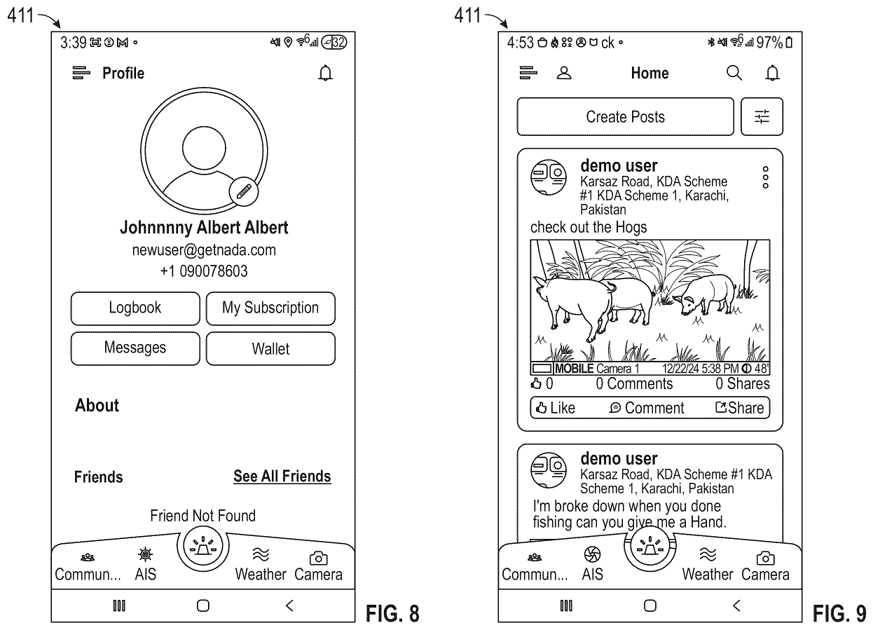

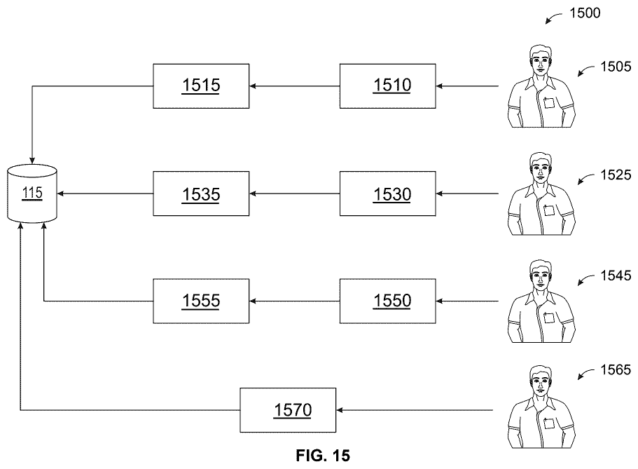

FIGS. 4-15 illustrate comprehensive embodiments of the outdoor recreation safety and communication system 400 and associated methods for managing hunter safety and coordination in approved hunting areas through GPS-based real-time location tracking, proximity monitoring, and emergency response capabilities. FIG. 4 illustrates a preferred embodiment of the system 400 having a computing device 410 with user interface 411, a GPS device 407, and a processor 220 operably connected to said computing device 410. FIG. 5 illustrates the emergency alert communication network architecture featuring the SOS functionality that enables rapid emergency response coordination among multiple hunters and predesignated emergency contacts through network-based alert transmission. FIG. 6 illustrates the automated check-in timer functionality that provides systematic safety monitoring by requiring hunters to confirm their safety at predetermined intervals and automatically triggering emergency protocols when check-ins are missed. FIG. 7 illustrates the customizable safety radius configuration system that establishes proximity monitoring zones around each hunter based on firearm specifications and activity types, with color-coded visual indicators for different outdoor recreation activities. FIGS. 8-14 present detailed examples of the mobile application user interface 411 of the computing device 410, wherein the display 316 operably connected to said computing device 410 presents the various data of the system, including user data 430A, location data 430B, safety data 430C, and image data 430D, social media feeds, digital logbooks, and emergency response controls. FIG. 15 illustrates the role-based security architecture configured to utilize permission levels 1500 for managing authorized access to the various data of the system. It is understood that the various method steps associated with the methods of the present disclosure may be carried out as operations by the system 400 shown in FIGS. 4-15.

The system 400 generally comprises one or more computing devices 410 having a user interface 411, processor 220 operably connected to said one or more computing devices 410, display 316 operably connected to said processor 220, and non-transitory computer-readable medium (CRM) 416 coupled to said processor 220 and having instructions stored thereon. Some preferred embodiments may further comprise a camera operably connected to said one or more computing device 410. In one preferred embodiment, a database 115 may be operably connected to the processor 220 and the various data of the system 400 may be stored therein, including, but not limited to, user data 430A, location data 430B, safety data 430C, and image data 430D. In yet another preferred embodiment, a wireless communication interface may allow the processors 220 of the system 400 to receive and transmit the various data of the system therebetween. In yet another preferred embodiment, a server 110 operably connected to the processor 220 may be used to facilitate the transfer of the data between the various databases 115 and computing devices 410 of the system 400. Though referred to as a single computing device 410 of a particular user 405, one with skill in the art will recognize that multiple computing devices 410 of multiple users may be used without departing from the inventive subject matter described herein.

In a preferred embodiment, the system 400 is configured to organize and manage the various data types within structured user profiles 430 that serve as repositories for individual user information and activity records. Each user profile 430 is specifically associated with a particular user 405 engaged in outdoor recreational activities, including, but not limited to hunting, hiking, or fishing, enabling personalized safety monitoring and communication features tailored to individual needs and preferences. The association between a user 405 and their corresponding user profile 430 is preferably established through unique username credentials, though alternative identification methods, including, but not limited to, biometric authentication, device-specific identifiers, and/or multi-factor authentication protocols, may be employed without departing from the inventive subject matter described herein. In a preferred embodiment, as illustrated in FIG. 4, user profiles 430 contain multiple categories of data, including, but not limited to, user data 430A, location data 430B, safety data 430C, and image data 430D, each serving specific functions within the comprehensive safety and communication framework. In some preferred embodiments, the system 400 may comprise a database 115 operably connected to the processor 220. The database 115 may be configured to store user data 430A, location data 430B, safety data 430C, and image data 430D within said user profiles 430, providing secure storage and efficient retrieval capabilities for all user profile information and associated outdoor recreation data. The database 115 maintains data integrity and accessibility while supporting real-time updates and synchronization across multiple devices used by outdoor recreation participants during their activities in remote wilderness environments.

In a preferred embodiment, user data 430A may be defined as personal information associated with a user 405 that enables the system 400 to establish user identity, track preferences, and facilitate personalized safety and communication features for outdoor recreational activities. The user data 430A encompasses various categories of information that support user authentication, profile management, and customized system functionality tailored to individual outdoor recreation needs and safety requirements. Types of data that may be utilized by the system 400 as user data 430A include, but are not limited to, a user's full name, unique username credentials, designated secondary users 405F for emergency contact purposes, social security number for identity verification, phone number for communication and alert delivery, gender demographics, age information for activity-appropriate safety protocols, and extracurricular preferences that indicate specific outdoor recreation interests such as hunting, fishing, or hiking activities. In some preferred embodiments, the user data 430A may include additional personal identifiers such as emergency contact information, medical alert data, equipment preferences, and skill level indicators that help the system 400 provide appropriate safety recommendations and activity-specific features. The system 400 may store user data 430A within the database 115 in encrypted format to protect sensitive personal information while maintaining accessibility for authorized system functions and user profile management. As illustrated in FIG. 4, the user data 430A forms a component of the comprehensive user profile 430 that enables personalized outdoor recreation safety monitoring and communication capabilities.

In a preferred embodiment, location data 430B may be defined as geographic and spatial information that enables precise positioning and navigation capabilities for users engaged in outdoor recreational activities such as hunting, hiking, and fishing. The location data 430B encompasses various categories of geographic information that support real-time tracking, route planning, and spatial analysis within the safety and communication framework of the system 400. As illustrated in FIG. 4, the location data 430B forms a component of the user profile 430 and may be stored within the database 115 for secure access and management by the processor 220. Types of data that may be utilized by the system 400 as location data 430B including, but not limited to, GPS coordinates captured from the GPS device 407, waypoint markers for navigation reference, boundary configurations for approved hunting areas, and elevation data for terrain analysis during outdoor activities. In another preferred embodiment, the location data 430B may include historical tracking information that documents user movement patterns, preferred hunting locations, and successful fishing spots to support future outdoor recreation planning and decision-making. The system 400 may utilize location data 430B to establish customizable safety radii around users, monitor proximity between multiple outdoor recreation participants, and provide real-time location sharing capabilities that enhance coordination and safety during group activities in remote wilderness environments.

In a preferred embodiment, safety data 430C may be defined as information pertaining to the safety configurations, alert preferences, and emergency response settings associated with a user 405 engaged in outdoor recreational activities, such as hunting, hiking, or fishing. The safety data 430C encompasses various categories of safety-related information that enable the system 400 to provide personalized safety monitoring and alert functionality tailored to individual user preferences and activity requirements. As illustrated in FIG. 4, the safety data 430C forms a component of the user profile 430 and is stored within the database 115 for secure access and management by the processor 220. Types of data that may be utilized by the system 400 as safety data 430C include, but are not limited to, customizable alert threshold settings that determine when proximity warnings should be triggered based on the approach of other hunters or outdoor recreation participants. In another preferred embodiment, the safety data 430C may include emergency contact information, medical alert data, and preferred communication methods for receiving safety notifications during outdoor activities. The safety data 430C may also encompass boundary configuration settings that define geographic limits and restricted areas for specific outdoor recreation activities, enabling users to establish personalized safety zones based on their experience level and activity requirements. In some preferred embodiments, the safety data 430C may include timing preferences for check-in intervals, automatic alert escalation procedures, and customizable safety radius dimensions that correspond to specific equipment types, such as firearms or other outdoor recreation gear used during hunting expeditions.

In a preferred embodiment, image data 430D may be defined as photographic and visual information that represents underlying pixel data captured from outdoor recreational environments, terrain features, and wildlife observations through digital imaging devices, such as cameras operably connected to the computing device 410. The image data 430D encompasses various types of visual documentation including terrain photographs that depict the topographical characteristics of hunting areas, hiking trails, and fishing locations within the geographic information system interface. As illustrated in FIG. 4, the image data 430D forms a component of the user profile 430 and may be stored within the database 115 for secure access and management by the processor 220. In another preferred embodiment, the image data 430D may include animal sighting photographs captured at specific geolocations, enabling users to document wildlife encounters and share valuable information about animal behavior and habitat patterns with other outdoor recreation participants. The system 400 may utilize image data 430D to create visual markers on interactive maps that correspond to specific geographic coordinates provided by the GPS device 407, allowing users to associate photographic evidence with precise location information. In some preferred embodiments, the image data 430D may include metadata information such as timestamp data, GPS coordinates, camera settings, and environmental conditions that provide comprehensive context for each captured image within the outdoor recreation safety and communication platform.

As illustrated in FIG. 4, the system 400 operates within the environment 100 and comprises several interconnected components that facilitate comprehensive outdoor recreation safety and communication functionality for hunters, hikers, and other outdoor enthusiasts. The system 400 includes the GPS device 407 that may be configured to detect and transmit geospatial data for tracking user 405 locations in real-time across approved hunting areas, fishing zones, and hiking trails. The processor 220 may be operably connected to the GPS device 407 and may receive the transmitted geospatial data for processing and analysis, enabling the system to monitor multiple users simultaneously across diverse outdoor environments. In a preferred embodiment, the computing device 410 may be operably connected to the processor 220 and may provide the user interface 411 through which the user 405 can interact with various system features, including, but not limited to, emergency alerts, proximity monitoring, and collaborative communication tools. The database 115 may be operably connected to the processor 220 and may store the user profiles 430 containing various types of data including the user data 430A for personal identification, the location data 430B for geographic tracking, the safety data 430C for alert preferences, and the image data 430D for wildlife documentation and terrain mapping. In some preferred embodiments, the system 400 may utilize cloud computing infrastructure to store and manage user data, including profiles, logs, and GPS coordinates, ensuring scalable and accessible data management across multiple users and devices while maintaining real-time synchronization for group outdoor activities.

The GPS device 407 may be a single component of a larger computing device 410. A computing device 410 is intended to represent various forms of digital computers, such as laptops, desktops, workstations, servers, databases, mainframes, and other appropriate computers used for outdoor recreation safety and communication. In one preferred embodiment, the GPS device 407 may comprise a plurality of devices working together to obtain geospatial data via triangulation for tracking hunters in approved hunting areas. In a preferred embodiment, the GPS device 407 is a GPS sensor configured to detect and transmit geospatial data for real-time location tracking of multiple hunters. The GPS sensor may measure and transmit geospatial data relevant for determining real-time locations of hunters within approved hunting areas and establishing customizable safety radii around each hunter. A GPS sensor may be defined as a receiver having an antenna designed to communicate with a navigation satellite system for outdoor recreation safety monitoring. Geospatial data may be spatial data including, but not limited to, numeric data, vector data, and raster data, or any combination thereof used for hunter location tracking and proximity monitoring. Numeric data may be statistical data which includes a geographical component or field that can be joined with vector files so the data may be queried and displayed as a layer on a map in the interactive map interface of the system 400. Vector data may be data that has a spatial component, or X, Y coordinates assigned to it for tracking hunter positions and safety boundaries. Vector data may contain sets of points, lines, or polygons that are referenced in a geographic space for establishing customizable boundary areas and safety radii. Raster data may be data in a .JPG, .TIF, .GIF or other picture file format used for terrain visualization and animal sighting documentation. For instance, a map scanned in a flatbed scanner may be considered raster data for displaying hunting area boundaries. In a preferred embodiment, the GPS device 407 is part of a mobile computing device 410 that provides the user interface 411 for outdoor recreation safety and communication functionality.

The processor 220 may be coupled to a non-transitory computer-readable medium 416 that contains instructions stored thereon, which when executed by the processor 220, cause the processor 220 to perform various operations related to safety monitoring and communication for outdoor recreational activities. In a preferred embodiment, the non-transitory computer-readable medium 416 may store executable code that enables the processor 220 to receive the geospatial data transmitted by the GPS device 407 and determine real-time locations of multiple hunters within approved hunting areas, while simultaneously calculating proximity distances and potential safety zone violations. The computing device 410 may be configured to receive geospatial data via the user interface 411, enabling seamless interaction between users and the system's location tracking capabilities through intuitive map displays and control interfaces. In another preferred embodiment, the system 400 may include a safety alert 409 component that provides notification functionality for proximity alerts, boundary notifications, and emergency alerts to users based on real-time location analysis performed by the processor 220, ensuring rapid response to potential safety situations during outdoor activities. The safety alert 409 may be configured to send notifications through various communication channels including SMS, email, and in-app notifications to ensure reliable delivery of safety information to hunters, emergency contacts, and other designated recipients. In some preferred embodiments, the system 400 may employ advanced encryption techniques for data both in transit and at rest to protect sensitive information such as user profiles, emergency contacts, and GPS coordinates from unauthorized access, while maintaining the system's ability to provide real-time safety monitoring and communication capabilities for outdoor recreation participants.

In a preferred embodiment, the system 400 may implement authentication mechanisms specifically designed to verify user identities and maintain security protocols for outdoor recreational activities such as hunting, hiking, and fishing. The authentication system may utilize one-time passwords (OTP) transmitted via email or SMS to ensure that only authorized individuals can access their user profiles 430 and associated safety features during outdoor recreation sessions. As illustrated in FIG. 4, the processor 220 may coordinate with the server 110 and/or database 115 to validate user credentials and manage secure access to user data 430A, location data 430B, safety data 430C, and image data 430D. The authentication process may be designed to function reliably even in remote outdoor environments where cellular connectivity may be intermittent, ensuring that users can access safety features when needed most. In another preferred embodiment, the system 400 may provide social login integration through platforms including, but not limited to, Google and Apple authentication services, enabling streamlined user registration while maintaining robust security standards for outdoor recreation safety applications. The authentication mechanisms may include multi-factor verification processes that combine password authentication with device-specific tokens to prevent unauthorized access to safety monitoring and emergency response capabilities.

As illustrated in FIG. 5, the system 400 may implement an emergency alert communication network architecture that facilitates rapid response capabilities during outdoor recreational activities such as hunting, hiking, and fishing in remote wilderness environments. The network 150 may serve as the central communication infrastructure connecting multiple system components and users to enable comprehensive emergency response functionality across diverse outdoor terrain conditions. A first primary user 405A may be positioned within the network 150 and may be operably connected to a GPS device 407 that provides real-time location tracking and geospatial data transmission capabilities for precise coordinate determination during outdoor recreation emergencies. The first primary user 405A may be associated with a button activation 1201 mechanism that enables emergency alert initiation through deliberate user interaction with the system interface, ensuring that emergency protocols are activated only when genuinely needed. An SOS button 1203 may be operably connected to the button activation 1201 and may provide the primary emergency response trigger for the system 400, enabling immediate communication with nearby outdoor recreation participants and designated emergency contacts. In a preferred embodiment, the emergency alert system may be accessible via a centrally located action button that must be held down for 3 seconds to activate a menu with Live and SOS options, ensuring deliberate activation while preventing accidental emergency alerts that could disrupt outdoor recreation activities or waste emergency response resources.

In a preferred embodiment, the network 150 may facilitate communication between the first primary user 405A and multiple recipient users positioned throughout the outdoor recreation area, enabling coordinated safety monitoring and emergency response capabilities for hunting, hiking, and fishing activities. As illustrated in FIG. 5, the second primary user 405B, third primary user 405C, fourth primary user 405D, and fifth primary user 405E may be connected to the network 150 via their respective computing device 410 configured to receive emergency alerts and location information transmitted through the communication infrastructure, providing immediate awareness of safety situations affecting other outdoor recreation participants and ensuring that emergency notifications reach all available users regardless of their distance from the initiating user. The secondary users 405F may also be connected to the network 150 via their respective computing devices 410, which may also be configured to receive emergency notifications and alerts as part of the comprehensive safety communication system, including, but not limited to, emergency contacts, family members, and designated monitoring personnel who can coordinate external assistance when outdoor recreation emergencies occur. In some preferred embodiments, the system 400 may display real-time locations of hunters on an interactive map interface, enabling all connected users to maintain situational awareness during outdoor activities and facilitating coordinated group movements, safety zone monitoring, and collaborative hunting strategies that enhance both safety and recreational success.

In a preferred embodiment, the system 400 may implement privacy control functionality that enables users 405 to selectively disable location sharing features through the user interface 411 during outdoor recreational activities such as hunting, hiking, and fishing. The privacy control system may allow primary users 405A, 405B, 405C, 405D, 405E to temporarily or permanently hide their real-time location information from other primary users within the safety and communication network while maintaining access to other system features. As illustrated in FIG. 5, the network 150 architecture supports flexible visibility configurations that enable users to customize their location sharing preferences based on specific outdoor recreation scenarios and personal privacy requirements. In some preferred embodiments, the processor 220 may execute instructions stored on the non-transitory computer-readable medium 416 to manage location visibility settings that allow users to control which other participants can view their position data during group outdoor activities. The privacy control functionality may include granular permission settings that enable users to share location information with designated emergency contacts while hiding their position from general system users, providing balanced safety monitoring and privacy protection. The system 400 may store privacy preferences within the safety data 430C component of user profiles 430, ensuring that location visibility settings are consistently applied across multiple outdoor recreation sessions and device configurations.

In a preferred embodiment, the SOS button 1203 may be configured to initiate comprehensive emergency response protocols that transmit GPS coordinates and safety alerts to nearby hunters and predesignated emergency contacts when activated through the button activation 1201 mechanism during outdoor recreational activities. The emergency alert system may provide immediate notification capabilities that enable rapid mobilization of assistance resources across diverse outdoor environments, including, but not limited to, remote hunting areas, hiking trails, and fishing locations where traditional communication infrastructure may be limited or unavailable. As illustrated in FIG. 5, the system 400 may transmit emergency alerts along with precise GPS coordinates from the GPS device 407 through the network 150 to the second primary user 405B, third primary user 405C, fourth primary user 405D, fifth primary user 405E, and secondary users 405F simultaneously, ensuring comprehensive coverage of available assistance resources. The emergency response capabilities may include automated escalation procedures that contact additional emergency services if initial alerts are not acknowledged within predetermined time intervals, providing multiple layers of safety protection for outdoor recreation participants. In another preferred embodiment, the SOS button 1203 may cause the action button to blink when activated and may display the GPS coordinates and safety radius of an emergency user as color-coded indicators to help other users locate the emergency user during response efforts. The processor 220 may execute instructions stored on the non-transitory computer-readable medium 416 to coordinate the emergency alert transmission process and ensure reliable delivery of safety information across the network 150, maintaining system functionality even in challenging environmental conditions that may affect communication reliability. In some preferred embodiments, the system 400 may implement push notification capabilities for sending targeted alerts and location-based information to users based on their preferences and geographic position, enabling customized emergency response protocols that account for different outdoor recreation scenarios, terrain conditions, and user activity types such as hunting expeditions, backcountry hiking, or remote fishing activities.

In a preferred embodiment, the emergency alert communication network may implement advanced real-time communication protocols specifically designed to facilitate instant message transmission between the first primary user 405A and multiple recipient users through the network 150 infrastructure during outdoor recreational emergencies. The communication protocols may be engineered with redundancy features and adaptive routing capabilities that maintain reliable connectivity even in challenging outdoor environments where hunters, hikers, and fishing enthusiasts frequently encounter limited cellular coverage or intermittent network availability. As illustrated in FIG. 5, the GPS device 407 may continuously transmit precise geospatial coordinates through the network 150 to maintain accurate location tracking for all connected users during emergency situations, enabling coordinated response efforts across diverse outdoor terrain conditions. The system 400 may employ distributed cloud computing infrastructure with edge processing capabilities to support real-time communication between the first primary user 405A and recipient users, ensuring instant delivery of emergency alerts and location updates across the distributed network architecture regardless of geographic distance or environmental obstacles. In another preferred embodiment, the emergency alert system may incorporate intelligent automatic escalation procedures that systematically contact additional emergency services, including, but not limited to, local search and rescue teams, park rangers, and emergency medical services, if initial alerts are not acknowledged within predetermined time intervals ranging from five to fifteen minutes depending on the severity level of the emergency situation. In some preferred embodiments, the network 150 may support comprehensive bidirectional communication capabilities that allow recipient users to respond to emergency alerts with status updates, coordinate assistance efforts, and share real-time information about their approach routes and estimated arrival times through the same communication infrastructure used for initial alert transmission and ongoing safety monitoring during outdoor recreational activities.

As illustrated in FIG. 6, the system 400 may implement a check-in timer functionality that enables automated safety monitoring and emergency response capabilities for outdoor recreational activities, such as hunting, hiking, and fishing in remote wilderness environments. The network 150 may facilitate communication between multiple system components to provide continuous safety oversight for users engaged in potentially hazardous outdoor environments where traditional communication infrastructure may be limited or unavailable. A first primary user 405A may be positioned within the network 150 and may be operably connected to a check-in timer 504 that manages predetermined safety confirmation intervals based on the specific risks and duration of outdoor recreational activities. The check-in timer 504 may be configured to require the first primary user 405A to confirm their safety at customizable time intervals ranging from minutes to hours, providing a systematic approach to monitoring user welfare during extended outdoor recreation sessions. A computer readable signal in the form of a safety alert 409 may be sent by the system 400 when the rules of the check-in timer 504 are violated, such as when check-ins are missed by the first primary user 405A, ensuring that designated monitoring contacts receive timely updates about user safety status. The GPS device 407 may be connected to the network 150 and may provide continuous location tracking capabilities that support the check-in monitoring system with real-time geospatial data, enabling precise coordinate transmission during safety confirmations and emergency situations.

In a preferred embodiment, the check-in timer 504 may be accessible via an active screen slide-out interface that provides comprehensive customization options for safety monitoring during outdoor recreational activities such as hunting, hiking, and fishing expeditions. The first primary user 405A can establish their preferred confirmation intervals through the user interface 411, with timing options specifically tailored to the hazards and duration of their planned outdoor activities. As illustrated in FIG. 6, the system 400 enables the first primary user 405A to customize timer intervals ranging from minutes to hours, accommodating diverse outdoor recreation scenarios including, but not limited to, short-term hunting sessions, extended backcountry hiking trips, and multi-day fishing expeditions. The check-in timer 504 generates automated notifications that appear on the computing device 410 of the first primary user 405A, requiring deliberate acknowledgment through the user interface 411 to confirm continued safety and operational status. In another preferred embodiment, the processor 220 executes instructions stored on the non-transitory computer-readable medium 416 to implement comprehensive check-in functionality that systematically monitors user welfare throughout outdoor recreation activities. The system 400 maintains a monitoring relationship between a designated user 405 and the first primary user 405A, enabling authorized contacts to track safety status and receive timely updates about individuals engaged in potentially hazardous outdoor environments where traditional communication infrastructure may be limited or unavailable.

In a preferred embodiment, the safety alert 409 may be configured as a computer readable signal transmitted to computing devices in the form of messages that notify designated monitoring contacts when check-ins are successfully completed by the first primary user 405A during outdoor recreational activities such as hunting, hiking, or fishing expeditions. The safety alert 409 provides confirmation that the monitored individual remains safe and operational within their designated outdoor recreation area, enabling monitoring contacts to maintain awareness of the first primary user's 405A welfare status throughout extended outdoor activities. The system 400 may transmit confirmation alerts through the network 150 to the user 405, indicating that the first primary user 405A has responded appropriately to the check-in timer 504 and confirmed their continued safety status during their outdoor recreation session. The processor 220 may process check-in confirmations received from the first primary user 405A and may generate corresponding computer readable signals that are formatted as safety alert 409 messages for transmission to designated monitoring contacts. These confirmation messages may include timestamp information, location data from the GPS device 407, and status indicators that provide comprehensive safety monitoring information for outdoor recreation participants. In another preferred embodiment, the safety alert 409 may utilize multiple communication channels including, but not limited to, SMS text messaging, email notifications, and in-app alert systems to ensure reliable delivery of check-in confirmations to the user 405 and other designated monitoring contacts regardless of their preferred communication methods or device capabilities.

In another preferred embodiment, the system 400 may implement automated emergency response protocols that trigger the SOS button 1203 functionality when check-ins are missed three consecutive times by the first primary user 405A during outdoor recreational activities such as hunting, hiking, or fishing expeditions. The check-in timer 504 may continuously monitor response patterns from the first primary user 405A and may systematically escalate safety concerns when predetermined thresholds for missed confirmations are exceeded, ensuring safety oversight for users engaged in potentially hazardous outdoor environments. The processor 220 may execute additional instructions stored on the non-transitory computer-readable medium 416 to automatically activate emergency protocols that function independently of manual user intervention, providing reliable safety monitoring even when outdoor recreation participants are unable to respond due to injury, equipment failure, or environmental hazards. As illustrated in FIG. 6, the automated SOS activation process may generate safety alerts in the form of computer readable signals transmitted to computing devices 410, which notify nearby users 405 and predesignated emergency contacts about the safety status of the first primary user 405A through comprehensive message-based communication systems. The safety alert 409 may initiate emergency protocols that transmit precise GPS coordinates from the GPS device 407 along with detailed emergency notifications to multiple recipients through the network 150, enabling coordinated response efforts across diverse outdoor terrain conditions. In some preferred embodiments, the automatic SOS activation may cause the system 400 to display the location and safety radius of the first primary user 405A as color-coded indicators on interactive maps viewed by other users, facilitating rapid identification and assistance efforts during outdoor recreation emergencies where time-sensitive response coordination may determine the outcome of safety situations.

In a preferred embodiment, the check-in timer 504 may provide adaptive flexibility that enables the first primary user 405A to dynamically adjust monitoring intervals based on evolving environmental conditions, terrain challenges, and specific activity requirements encountered during extended outdoor recreation sessions. The system 400 may accommodate varying outdoor recreation scenarios by allowing users to modify check-in frequencies when engaging in activities such as deep wilderness hunting, backcountry fishing expeditions, or multi-day hiking adventures where device accessibility may be temporarily restricted. As illustrated in FIG. 6, the processor 220 may analyze location data 430B from the GPS device 407 in conjunction with parameters of the check-in timer 504 to provide comprehensive safety monitoring that integrates both temporal scheduling and spatial positioning factors within emergency response protocols. The safety alert 409 may generate differentiated computer readable signals transmitted to computing devices in the form of messages that provide distinct notification types for successful check-ins, single missed check-ins, and automatically triggered emergency alerts, enabling monitoring contacts to assess the severity and nature of each safety communication. In some preferred embodiments, the network 150 may facilitate bidirectional communication capabilities between the user 405 and the first primary user 405A, allowing designated monitoring contacts to transmit acknowledgments, safety instructions, or status updates in response to check-in notifications received through the safety communication system. The system 400 may maintain comprehensive check-in timer 504 data within the safety data 430C component of the user profile 430, enabling longitudinal analysis of safety monitoring patterns and systematic optimization of check-in intervals for enhanced outdoor recreation safety management across diverse environmental conditions and activity types including, but not limited to, hunting, fishing, hiking, and camping expeditions.

As illustrated in FIG. 7, the system 400 may implement a comprehensive safety radius configuration and proximity monitoring system that provides real-time spatial awareness for multiple users engaged in outdoor recreation activities across varied terrain conditions. The GPS device 407 may be positioned at an elevated location within the outdoor environment and may be operably connected to the network 150 via communication links to establish continuous data transmission with multiple primary users distributed across the terrain. In a preferred embodiment, the first primary user safety radius 605 may be established around the first primary user 405A to create a customizable safety zone that can be manually configured or selected from preinstalled modes tailored to specific firearms, including, but not limited to, rifles, shotguns, and archery equipment. The safety radius configuration enables the processor 220 to monitor when other users approach within predetermined distances and generate safety alerts as computer readable signals transmitted to computing devices in the form of messages that notify users of potential proximity violations. The second primary user safety radius 606 may be configured around the second primary user 405B to provide individualized proximity monitoring based on the specific equipment and activity requirements of that user, ensuring that safety protocols are adapted to different outdoor recreation scenarios. In another preferred embodiment, the system 400 may store safety radius preferences within the safety data 430C component of user profiles 430, enabling consistent application of personalized safety settings across multiple outdoor recreation sessions.

The third primary user safety radius 607 may be positioned around the third primary user 405C to ensure comprehensive spatial monitoring across the outdoor recreation area, while the fourth primary user safety radius 608 may be established around the fourth primary user 405D to complete the multi-user safety monitoring network within the designated outdoor terrain 609. In some preferred embodiments, the processor 220 may execute instructions stored on the non-transitory computer-readable medium 416 to continuously calculate distances between users and compare these measurements against configured safety radius dimensions to determine when proximity thresholds are approached or exceeded. The system 400 may generate safety alert notifications 612 as computer readable signals transmitted to computing devices in the form of messages when safety radius boundaries are crossed, providing immediate notification to affected users about potential safety concerns during hunting, hiking, or fishing activities. The safety alert notifications 612 may be transmitted through the network 150 to the computing devices 410 of both users involved in the proximity violation, ensuring that all affected parties receive immediate awareness of the safety situation. As illustrated in FIG. 7, the outdoor terrain 609 may be represented by irregular boundaries that indicate the geographical area within which the primary users are operating during their outdoor recreation activities. In a preferred embodiment, the GPS device 407 may establish communication lines that extend to each of the primary users 405A, 405B, 405C, 405D, illustrating the network connectivity that enables real-time location tracking and proximity monitoring across the varied topography of the outdoor terrain 609.

In a preferred embodiment, the processor 220 may execute instructions stored on the non-transitory computer-readable medium 416 to establish customizable safety radius configurations around each hunter displayed on an interactive map interface, enabling comprehensive real-time visualization of safety zones for all active users engaged in outdoor recreational activities. The safety radius establishment process allows users to define protective boundaries that correspond to their specific hunting equipment, environmental conditions, and personal safety preferences during outdoor recreation sessions. As illustrated in FIG. 7, the first primary user safety radius 605, second primary user safety radius 606, third primary user safety radius 607, and fourth primary user safety radius 608 may be represented as concentric circles around each user's location, providing clear visual indicators of safety boundaries on the user interface 411. The system 400 may enable users to manually configure the dimensions of their respective safety radii through intuitive interface controls that accommodate various outdoor recreation scenarios, including, but not limited to, rifle hunting, archery activities, and group coordination exercises. In another preferred embodiment, the safety radius may be selected from preinstalled modes tailored to specific firearms and outdoor equipment, allowing users to quickly configure appropriate safety distances based on the range characteristics and safety requirements of their hunting equipment. The processor 220 may store safety radius configurations within the safety data 430C component of each user profile 430, enabling consistent application of personalized safety settings across multiple outdoor recreation sessions and ensuring that safety preferences are maintained throughout extended hunting expeditions.

In a preferred embodiment, the system 400 may implement terrain-adaptive safety radius modification capabilities that automatically adjust the customizable safety radius dimensions based on the specific topographical characteristics and environmental conditions of the outdoor recreation area where users are operating. The processor 220 may execute additional instructions stored on the non-transitory computer-readable medium 416 to analyze terrain data received from the GPS device 407 and geographic information system layers to determine appropriate safety radius adjustments for different landscape features including, but not limited to, steep slopes, dense vegetation, rocky outcroppings, and water bodies that may affect visibility and communication between outdoor recreation participants. As illustrated in FIG. 7, the terrain-adaptive functionality may modify the first primary user safety radius 605, second primary user safety radius 606, third primary user safety radius 607, and fourth primary user safety radius 608 based on the specific characteristics of the outdoor terrain 609 surrounding each user's position. In another preferred embodiment, the terrain analysis system may increase safety radius dimensions in areas with limited visibility such as dense forest environments or mountainous terrain where natural obstacles may obstruct sight lines between hunters, hikers, or fishing enthusiasts engaged in outdoor recreational activities. The system 400 may generate safety alert notifications 612 as computer readable signals transmitted to computing devices in the form of messages when terrain-modified safety boundaries are approached or crossed, ensuring that users receive appropriate warnings based on the actual environmental conditions rather than generic distance measurements. In some preferred embodiments, the terrain-adaptive safety radius system may integrate with the layers menu interface to utilize topographic, satellite, and 3D terrain visualization data for enhanced accuracy in determining appropriate safety zone modifications for diverse outdoor recreation scenarios.

In a preferred embodiment, the system 400 may implement a color-coding system for different activity modules that provides immediate visual identification of user activities and associated safety requirements during outdoor recreational pursuits. The color-coding system enables users to distinguish between various types of outdoor recreation activities including, but not limited to, hunting expeditions, hiking adventures, and fishing excursions through distinctive visual indicators displayed on the interactive map interface. Hunting activities may be displayed in orange coloring for the safety radii, enabling other users to immediately identify hunters and their associated safety zones while maintaining situational awareness during group outdoor activities. Hiking activities may be displayed in blue coloring for the safety radii, allowing users to distinguish between different types of outdoor recreation activities and their corresponding safety protocols when multiple activity types are occurring simultaneously in the same geographic area. Fishing activities may be displayed in yellow coloring for the safety radii, providing comprehensive activity identification across diverse outdoor recreation scenarios and ensuring that users can quickly assess the nature of nearby activities. As illustrated in FIG. 7, the processor 220 may execute additional instructions stored on the non-transitory computer-readable medium 416 to monitor when hunters enter the customizable safety radius of other users and to send proximity alerts as computer readable signals transmitted to computing devices in the form of messages that notify both hunters when safety radius boundaries are crossed. In another preferred embodiment, the color-coding system may extend to the user interface 411 elements, ensuring that action buttons and interface components reflect the current activity mode and associated safety radius coloring for consistent visual feedback throughout the mobile application interface. In some preferred embodiments, the color coordination may synchronize across multiple interface screens and map displays, enabling users to maintain awareness of their current activity status regardless of which application screen they are viewing during their outdoor recreation session.

As illustrated in FIG. 7, the outdoor terrain 609 may be represented by irregular boundaries that define the geographical area within which the first primary user 405A, second primary user 405B, third primary user 405C, and fourth primary user 405D conduct their outdoor recreational activities, including, but not limited to, hunting expeditions, hiking adventures, and fishing excursions. The GPS device 407 may establish continuous communication pathways that extend to each of the primary users through the network 150, demonstrating the comprehensive connectivity infrastructure that supports real-time location tracking and proximity monitoring across diverse topographical features of the outdoor terrain 609. In a preferred embodiment, the system 400 may implement advanced proximity monitoring capabilities that continuously analyze the relative positions of multiple users and their established safety radii to prevent accidents and enhance coordination during outdoor recreational activities. The processor 220 may perform distance calculations that operate in real-time, comparing measured distances between users against their configured safety radius dimensions to determine when proximity thresholds are approached or exceeded based on personal settings, specific equipment types, and activity requirements. The safety alert notification 612 may be generated as a computer readable signal transmitted to computing devices in the form of messages that immediately notify affected users about potential safety concerns when safety radius boundaries are crossed during outdoor recreational pursuits. In another preferred embodiment, the safety alert notification 612 may be transmitted through the network 150 to the computing devices 410 of all users involved in proximity violations, ensuring comprehensive awareness of safety situations and enabling coordinated response efforts among outdoor recreation participants.

In another preferred embodiment, the processor 220 may execute additional instructions stored on the non-transitory computer-readable medium 416 to enable users to create customizable boundary areas by strategically dropping virtual pins along boundary lines within the outdoor terrain 609, providing precise geographic control for outdoor recreational activities. The system 400 may facilitate the establishment of complex geographic boundaries through an intuitive pin-placement interface that allows users to define specific areas for hunting zones, hiking trails, fishing locations, and restricted access regions with high precision and flexibility. The processor 220 may implement continuous monitoring algorithms that track when hunters, hikers, or other outdoor recreation participants approach the established boundary lines within predetermined distances, providing advance warning notifications before users inadvertently exit designated safe areas or enter restricted zones. The boundary alert system may generate computer readable signals transmitted to computing devices in the form of messages that notify designated users when predetermined distance thresholds from boundary lines are reached, enabling proactive safety management and regulatory compliance during outdoor recreational activities. In some preferred embodiments, the boundary monitoring functionality may operate in conjunction with the safety radius monitoring system to provide comprehensive spatial awareness that encompasses both user-to-user proximity detection and geographic boundary compliance verification. The processor 220 may store detailed boundary configurations within the location data 430B component of user profiles 430, ensuring consistent application of area restrictions, safety protocols, and regulatory compliance measures across multiple outdoor recreation sessions and diverse environmental conditions.

The system 400 may establish monitoring relationships between primary users and secondary users, enabling designated individuals to track movements, safety status, and compliance activities of other participants within the outdoor terrain 609 during recreational pursuits, including, but not limited to, hunting expeditions, backcountry hiking, and remote fishing activities. In a preferred embodiment, the processor 220 may execute additional instructions stored on the non-transitory computer-readable medium 416 to generate computer readable signals transmitted to computing devices in the form of messages that alert primary users when secondary users cross established boundary lines within outdoor recreation areas. The monitoring relationship establishment process may require explicit acceptance and consent from secondary users before location tracking, boundary monitoring, and safety oversight capabilities can be activated, ensuring user privacy protection and voluntary participation in safety monitoring programs. The system 400 may provide transparency regarding monitoring status by generating computer readable signals transmitted to computing devices in the form of messages that notify primary users when secondary users deactivate monitoring relationships, terminate location sharing, or modify their participation in safety oversight arrangements. The safety alert notification 612 may serve as the primary communication mechanism for transmitting boundary violations, monitoring status changes, and safety event notifications between primary and secondary users through the network 150 infrastructure. In some preferred embodiments, the monitoring relationship framework may include customization options that allow primary users to specify which types of boundary violations, safety events, proximity alerts, or emergency situations should trigger automatic notifications, enabling personalized safety management approaches tailored to specific outdoor recreational activities and risk assessment requirements.

As illustrated in FIG. 8, the system 400 may implement a user profile management interface that provides access to user information, system features, and digital documentation storage capabilities for outdoor recreational activities conducted in public and private hunting areas. The user interface 411 may display a profile screen that presents user data 430A in an organized and accessible format for efficient user interaction and system management during hunting expeditions, hiking adventures, and fishing activities on both state-owned public lands and privately designated hunting properties. The user interface 411 may show a profile section positioned at the top of the display that includes a user avatar, user name information, email address, and phone number for user identification and contact purposes during outdoor recreation safety monitoring. In a preferred embodiment, the profile information may be stored within the user data 430A component of the user profile 430 and may be accessible for viewing and modification through the user interface 411, enabling hunters and outdoor enthusiasts to maintain current contact information for emergency response coordination. The system 400 may enable users to update their personal information, change their profile picture, and manage their account settings through the profile management interface, ensuring that safety alerts can be transmitted as computer readable signals to computing devices in the form of messages that notify designated contacts about user safety status during outdoor activities. In another preferred embodiment, the user interface 411 may provide secure authentication mechanisms that verify user identity before allowing access to profile modification features, protecting sensitive personal information while maintaining the ability to share location data with authorized hunting partners and emergency contacts in approved hunting areas.

In a preferred embodiment, the user interface 411 may display four primary action buttons arranged in two rows below the profile information section to provide organized access to various system features and functionalities for outdoor recreational activities conducted on both private lands owned by private owners and public lands owned by state and federal governments. The “Logbook” button may be positioned in the first row and may provide access to digital documentation features that allow users to record comprehensive details of their outdoor recreation experiences including, but not limited to, location coordinates, date and time stamps, weather conditions, wildlife observations, and safety incidents encountered during hunting, hiking, or fishing activities. As illustrated in FIG. 8, the logbook functionality enables systematic record-keeping that supports regulatory compliance and safety monitoring across diverse outdoor environments. The digital logbook may automatically integrate GPS coordinates from approved hunting areas and public recreation zones, ensuring accurate documentation of user activities for both personal reference and regulatory reporting purposes. In another preferred embodiment, the logbook entries may be shared with designated emergency contacts or wildlife management authorities through safety alerts transmitted as computer readable signals to computing devices in the form of messages that notify recipients about user activity status and location history. The processor 220 may execute instructions stored on the non-transitory computer-readable medium 416 to manage logbook data storage within the user profile 430 and coordinate information sharing based on user permissions and safety protocols.

The “My Subscription” button may be positioned adjacent to the Logbook button in the first row and may enable users to manage their subscription status, payment information, and access to premium features within the system 400 for enhanced safety monitoring and communication capabilities during outdoor recreational activities. In some preferred embodiments, the subscription management interface may provide tiered access levels that correspond to different outdoor recreation scenarios, with basic subscriptions supporting individual safety monitoring and premium subscriptions enabling group coordination features for hunting parties operating on private hunting preserves or public wildlife management areas. The subscription system may integrate with third-party payment processors to facilitate secure transaction processing while maintaining user privacy and data protection standards required for outdoor recreation safety applications. Users may upgrade their subscription levels to access advanced features including, but not limited to, extended emergency contact lists, enhanced boundary monitoring capabilities, and priority emergency response coordination services. The system 400 may generate safety alerts as computer readable signals transmitted to computing devices in the form of messages that notify users when subscription renewals are required to maintain continuous safety monitoring services during planned outdoor activities. The processor 220 may coordinate subscription status verification with safety feature availability to ensure that users maintain appropriate service levels for their intended outdoor recreation activities on both private and public lands.

In another preferred embodiment, the “Messages” button may be positioned in the second row and may provide access to group chat functionality for real-time communication between users 405 engaged in outdoor recreation activities across diverse terrain conditions and property boundaries. The messaging system may support both individual and group communication channels that enable hunters, hikers, and fishing enthusiasts to coordinate activities, share safety information, and maintain contact while operating in remote areas where traditional cellular communication may be limited or unavailable. As illustrated in FIG. 8, the messaging interface may integrate with the safety monitoring system to automatically distribute location updates and safety status information through safety alerts transmitted as computer readable signals to computing devices in the form of messages that notify group members about participant locations and welfare status. The group chat functionality may include multimedia messaging capabilities that allow users to share photographs of wildlife sightings, terrain conditions, and safety hazards encountered during their outdoor activities on private hunting properties or public recreation areas. In some preferred embodiments, the messaging system may provide offline message queuing that stores communications when network connectivity is interrupted and automatically transmits messages when communication links are reestablished. The processor 220 may execute additional instructions stored on the non-transitory computer-readable medium 416 to manage message encryption, delivery confirmation, and group membership administration for secure communication among outdoor recreation participants.

The “Wallet” button may be positioned in the second row adjacent to the Messages button and may provide access to the digital wallet functionality that consolidates licenses and essential documentation within the application for convenient access during outdoor recreation activities on both private and public lands. In a preferred embodiment, the digital wallet may store hunting licenses, fishing permits, landowner permission documents, identification cards, and other regulatory documentation in secure digital format within the user profile 430, eliminating the need for users to carry physical documents during outdoor activities. The digital wallet functionality may include document verification capabilities that ensure uploaded licenses and permits are valid and current for the specific outdoor recreation activities being conducted, with automatic expiration date monitoring and renewal reminders. As illustrated in FIG. 8, the wallet interface may provide quick access to required documentation during regulatory inspections or emergency situations where identification and permit verification may be necessary. The system 400 may generate safety alerts as computer readable signals transmitted to computing devices in the form of messages that notify users when licenses are approaching expiration dates or when additional permits may be required for planned activities in specific geographic areas. In some preferred embodiments, the digital wallet may integrate with state and federal licensing databases to provide real-time validation of permit status and regulatory compliance for outdoor recreation activities conducted across different jurisdictions and property types.

In a preferred embodiment, the digital wallet functionality may enable users to consolidate hunting licenses, fishing permits, landowner permission documents, and identification cards within a centralized digital repository accessible through the user interface 411 during outdoor recreational activities. The digital wallet system may store regulatory documentation in secure encrypted format within the user data 430A component of the user profile 430, ensuring that sensitive permit information remains protected while maintaining accessibility for compliance verification during outdoor recreation sessions. The processor 220 may execute instructions stored on the non-transitory computer-readable medium 416 to manage document upload, storage, and retrieval processes that enable users to quickly access required documentation during regulatory inspections or emergency situations. In another preferred embodiment, the digital wallet may include automated document verification capabilities that validate uploaded licenses and permits against government databases to ensure compliance with current regulations for specific outdoor recreation activities and geographic locations. The system 400 may generate safety alerts as computer readable signals transmitted to computing devices in the form of messages that notify users when licenses are approaching expiration dates or when additional permits may be required for planned activities in specific jurisdictions. The digital wallet functionality may support various document formats including, but not limited to, PDF files, image files, and digital certificates commonly used for outdoor recreation permits and regulatory compliance documentation.

The user interface 411 may provide comprehensive access to system information and social networking capabilities through organized sections that enhance user experience during outdoor recreational activities on private hunting preserves and public wildlife management areas. In a preferred embodiment, an “About” section may be positioned below the primary action buttons and may contain static content including, but not limited to, privacy policies, terms of service, system documentation, and support resources that enable users to understand their rights and responsibilities while using the safety communication platform. The About section may provide detailed information about data collection practices, location sharing protocols, and emergency response procedures that govern system operation during outdoor recreation activities conducted across diverse property types and jurisdictions. A “Friends” section may be displayed below the About section and may include social networking functionality that enables users to establish connections with other outdoor recreation enthusiasts for collaborative hunting expeditions, fishing trips, and hiking adventures. In some preferred embodiments, the Friends section may display a “Friend Not Found” message when no social connections have been established, indicating that users can build networks for coordinated outdoor activities and mutual safety monitoring. The processor 220 may manage friend relationships and social connections within the user data 430A component, enabling users to share location information, coordinate group activities, and receive safety alerts as computer readable signals transmitted to computing devices in the form of messages that notify designated contacts about user safety status during outdoor recreation sessions.

As illustrated in FIG. 8, the user interface 411 may display a comprehensive navigation bar positioned at the bottom of the display that provides organized access to multiple system capabilities designed to enhance safety and communication during outdoor recreational activities on both private and public lands. The navigation bar may include a “Comments” icon that enables users to access social media functionality and interact with posts from other outdoor recreation participants, facilitating knowledge sharing about wildlife sightings, terrain conditions, and safety considerations across different hunting areas and fishing locations. An “AIS” icon may provide access to Automatic Identification System functionality specifically designed for users engaged in water-based outdoor recreation activities such as fishing expeditions, boating adventures, and marine safety monitoring in coastal and inland waterways. In another preferred embodiment, a central action button may be positioned prominently within the navigation bar and may provide immediate access to emergency response features including the SOS button 1203 activation and live mode functionality that enables real-time location sharing among group members during outdoor activities. A “Weather” icon may be integrated into the navigation bar to provide users with access to real-time meteorological information and extended weather forecasting capabilities that support outdoor recreation planning and safety decision-making for activities conducted in remote wilderness environments. The “Camera” icon may enable users to capture and document their outdoor recreation experiences through photographic documentation, with captured images being automatically stored as image data 430D within their user profile 430 and optionally shared with other users through the social media platform to contribute to the collaborative knowledge base of the outdoor recreation community.

As illustrated in FIG. 9, the system 400 may implement a social media feed interface that enables collaborative communication and information sharing among users engaged in outdoor recreational activities. The user interface 411 may display a home screen with a navigation bar positioned at the top showing “Home” in text, along with menu icons, a user profile icon, a search icon, and a notification icon for comprehensive system navigation across diverse outdoor recreation environments. The user interface 411 may show a “Create Posts” button and a menu icon positioned below the navigation bar to provide users with immediate access to content creation functionality for documenting their experiences in approved hunting areas and public recreation zones. In a preferred embodiment, the processor 220 may execute instructions stored on the non-transitory computer-readable medium 416 to provide group chat functionality for real-time communication between hunters, enabling seamless coordination and information sharing during outdoor recreation activities conducted across various property types and jurisdictions. The social media feed interface may enable users to create posts containing images, text descriptions, and location information about their outdoor recreation experiences, fostering a collaborative environment among outdoor enthusiasts operating in both private hunting preserves and public wildlife management areas. The system 400 may facilitate collaborative hunting through shared wildlife location markers 1207 on an interactive map interface, allowing users to contribute valuable information about wildlife sightings and hunting opportunities to the broader community while maintaining compliance with property boundaries and regulatory requirements for different land ownership types.

The user interface 411 may display posts from users within the social media feed. For instance, as illustrated in FIG. 9, a post may contain an image of hogs in a nighttime setting along with detailed location information and descriptive text may demonstrate wildlife documentation capabilities across international outdoor recreation areas. For instance, a post may display engagement metrics (such as likes, comments, and shares) and provide interactive buttons (such as like, comment, and share) for user interaction, enabling community members to engage with wildlife observation data from both private hunting properties and public recreation areas. In another preferred embodiment, the processor 220 may execute additional instructions stored on the non-transitory computer-readable medium 416 to receive animal location data when a user marks an animal sighting on a map, enabling systematic collection and organization of wildlife observation information for monitoring user activity in private and public outdoor activity areas. The system 400 may enable sharing of text messages and images through the group chat functionality, allowing users to communicate detailed information about hunting conditions, wildlife behavior, and safety considerations in real-time while operating across diverse property types and regulatory jurisdictions. The social media feed may support various content types including, but not limited to, photographs, videos, text descriptions, and location data to provide comprehensive documentation of outdoor recreation experiences. In some preferred embodiments, users may select an indicia on the GIS to access the social media feed screen, wherein the indicia represent locations where users have observed and described wildlife using the user interface 411, facilitating collaborative information sharing about animal behavior patterns and habitat utilization across different land ownership categories.

For instance, as illustrated in FIG. 9, a second post may be used to respond to the first post, displaying location information and text. This also demonstrates the system's capability to facilitate emergency assistance requests and community support among users engaged in outdoor recreational activities across various property boundaries and jurisdictions. The processor 220 may execute additional instructions stored on the non-transitory computer-readable medium 416 to display animal location data to other nearby users with customizable icons for specific animals, enabling immediate visual identification of wildlife species and locations on the interactive map interface for monitoring user activity in private and public outdoor activity areas. In a preferred embodiment, the system 400 may provide a comment system for users to add information about animal sightings, allowing detailed descriptions of wildlife behavior, environmental conditions, and hunting success factors to be shared with the community operating across private hunting preserves and public wildlife management areas. The social media feed interface may enable users to interact with posts through like, comment, and share functionality, creating an engaging platform for knowledge exchange and community building among outdoor recreation enthusiasts while maintaining awareness of property boundaries and regulatory compliance requirements for different land ownership types. The system 400 may store social media content within the image data 430D component of user profiles 430, ensuring that shared experiences and wildlife observations are preserved for future reference and analysis across diverse outdoor recreation environments. In some preferred embodiments, the social media feed may include search and filter capabilities that allow users to locate specific types of content, wildlife sightings, or posts from particular geographic areas, facilitating targeted information sharing about outdoor recreation opportunities.

The system 400 may implement community page functionality that connects users locally and globally for sharing tips, organizing group activities, and building collaborative relationships among outdoor recreation enthusiasts operating across diverse property types and regulatory jurisdictions. The community page feature may enable users to join discussions about hunting techniques, safety protocols, equipment recommendations, and local wildlife patterns, fostering knowledge sharing and skill development within the outdoor recreation community while maintaining compliance with regulations governing private and public land use. In another preferred embodiment, the processor 220 may execute additional instructions stored on the non-transitory computer-readable medium 416 to maintain a digital logbook for documenting hunting experiences, providing users with a comprehensive record-keeping system for their outdoor recreation activities. The digital logbook functionality may be accessed through the user interface 411 and may allow users to record location, date, time, and observations in the digital logbook, creating detailed documentation of hunting sessions, wildlife encounters, and environmental conditions across various outdoor recreation environments. The system 400 may enable users to share logbook entries with other hunters through the mobile application system, facilitating knowledge transfer and collaborative learning among community members so that designated contacts may be notified about user activity status and location history. The community page may support the organization of group hunting expeditions, fishing trips, and hiking activities by providing communication tools and coordination features that enable users to plan and execute collaborative outdoor recreation experiences across diverse property boundaries and regulatory frameworks.

In a preferred embodiment, the digital logbook may integrate with the GPS device 407 to automatically capture location data 430B for each documented experience, ensuring accurate geographic information is associated with hunting observations and wildlife sightings conducted across private hunting properties and public recreation areas. The processor 220 may store logbook entries within the user profile 430, enabling users to build comprehensive historical records of their outdoor recreation activities over time while maintaining detailed documentation of activities. The system 400 may provide customizable templates for logbook entries that guide users in documenting relevant information including, but not limited to, weather conditions, equipment used, wildlife observed, and hunting success metrics for comprehensive activity monitoring across diverse outdoor recreation environments. In some preferred embodiments, the digital logbook may include photo integration capabilities that allow users to attach images from their outdoor recreation experiences directly to logbook entries, creating rich multimedia documentation of hunting and wildlife observation activities as well as notifying monitoring contacts about user engagement and location status. The community page functionality may enable users to discover and connect with other outdoor recreation enthusiasts based on geographic proximity, shared interests, and activity preferences, building local and global networks of collaborative partners for activities conducted across various property types and regulatory jurisdictions. The system 400 may implement privacy controls for community interactions that allow users to manage the visibility of their posts, logbook entries, and personal information while participating in collaborative community activities and maintaining compliance with privacy requirements for monitoring user activity in private and public outdoor activity areas.

The social media feed interface may include real-time notification capabilities that alert users when new posts, comments, or wildlife sightings are shared within their geographic area or interest categories, facilitating immediate awareness of outdoor recreation opportunities and safety considerations. In another preferred embodiment, the processor 220 may analyze user interactions with social media content to provide personalized recommendations for hunting locations, wildlife observation opportunities, and community connections based on individual preferences and activity patterns documented across diverse property types and regulatory environments. The system 400 may enable users to create and join specialized groups within the community page based on specific outdoor recreation activities, geographic regions, or skill levels, facilitating targeted knowledge sharing and collaboration while maintaining awareness of property boundaries and regulatory compliance requirements for different land ownership categories. The digital logbook functionality may include data export capabilities that allow users to generate reports and summaries of their outdoor recreation activities for personal record-keeping, regulatory compliance, or sharing with hunting guides and outfitters operating across various outdoor recreation environments. In some preferred embodiments, the community page may integrate with local wildlife management agencies and conservation organizations to provide users with current information about hunting regulations, seasonal restrictions, and conservation initiatives. The social media feed may support multimedia content sharing including, but not limited to, videos, audio recordings, and interactive maps that enhance the richness and utility of shared outdoor recreation experiences and wildlife observations that notify community members about wildlife activity patterns and safety considerations across diverse outdoor recreation areas.

In a preferred embodiment, the system 400 may implement comprehensive wildlife tracking and predator alert functionality through the social media interface depicted in FIG. 9, enabling users 405 to create specialized wildlife location markers 1207 that enhance safety awareness during outdoor recreational activities. The wildlife tracking system allows users 405 to place customizable pins on the geographic information system interface of the user interface 411, providing collaborative wildlife observation data that benefits the entire outdoor recreation community. These specialized pins may include wild game pins that represent locations where users 405 have observed wildlife species during hunting, hiking, or fishing activities, creating a comprehensive database of animal activity patterns across diverse outdoor environments. In another preferred embodiment, the system 400 may support predator pins that mark locations where users 405 have encountered predator animals, including, but not limited to, bears, mountain lions, wolves, or other potentially dangerous wildlife species that pose safety risks to outdoor recreation participants. The predator alert system may be configured to generate safety alerts as computer readable signals transmitted to computing devices in the form of messages that warn users 405 when they approach within predetermined distances of marked predator locations based on their customizable safety radii. In some preferred embodiments, the predator warning system may provide differentiated alert levels based on the type of predator, time since the sighting was reported, and environmental conditions that may affect predator behavior patterns in specific geographic areas.

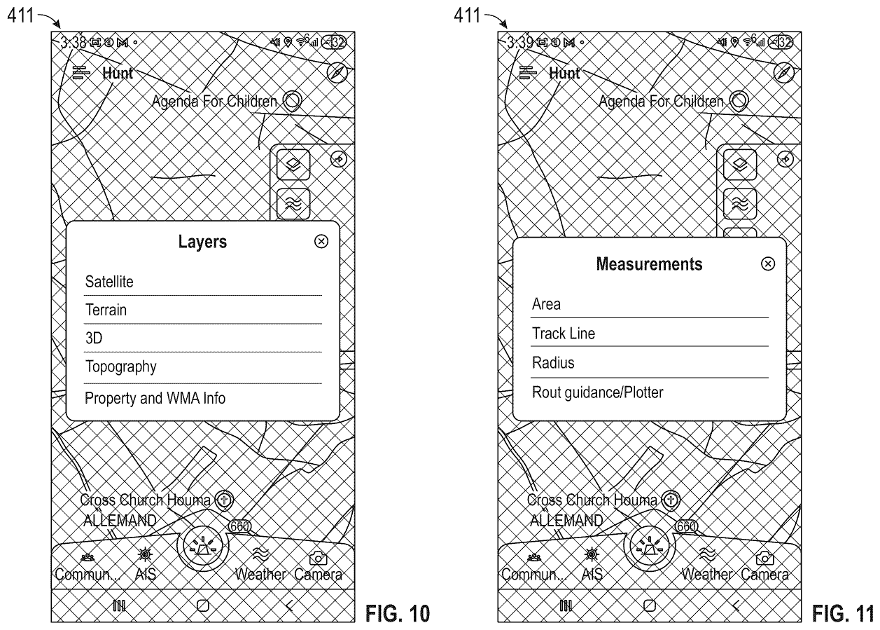

As illustrated in FIG. 10, the system 400 may implement a comprehensive layers menu interface that provides users with advanced geographic information system capabilities for customizing map visualization and navigation during outdoor recreational activities. The user interface 411 may display a layers menu overlay positioned on a map screen that enables users to select from multiple visualization options to optimize their mapping experience based on specific environmental conditions and navigation requirements encountered during hunting, hiking, and fishing activities across diverse property types and jurisdictions. The layers menu may include a dark overlay panel labeled “Layers” in the foreground that provides organized access to various map visualization modes while maintaining visibility of the underlying geographic features necessary for monitoring user activity in private and public outdoor activity areas. In a preferred embodiment, the layers panel may include several selectable options, including, but not limited to, “Satellite”, “Terrain”, “3D”, “Topography”, and “Property and WMA Info,” to provide mapping capabilities for diverse outdoor recreation scenarios. The processor 220 may execute instructions stored on the non-transitory computer-readable medium 416 to manage layer selection and rendering, ensuring that users can seamlessly transition between different map visualization modes based on their navigation needs and environmental conditions while maintaining compliance with property boundaries and regulatory requirements. The system 400 may store user layer preferences within the location data 430B component of the user profile 430, enabling consistent application of preferred map visualization settings across multiple outdoor recreation sessions conducted on various property types and regulatory jurisdictions.

The satellite layer option may provide users with high-resolution aerial imagery that displays real-world photographic representations of the outdoor terrain, enabling detailed visual assessment of geographic features, vegetation patterns, and man-made structures within hunting and recreation areas located on both private and public lands. In another preferred embodiment, the terrain layer may offer topographic visualization that emphasizes elevation changes, slope gradients, and natural geographic formations to assist users in navigation planning and safety assessment during outdoor activities as well as notify users about terrain-related safety considerations. The 3D layer option may provide three-dimensional map rendering capabilities that enable users to visualize elevation profiles and terrain features with enhanced depth perception for improved navigation and route planning in mountainous or complex geographic areas commonly found in both private hunting properties and public recreation zones. The topography layer may display detailed contour lines, elevation markers, and geographic reference points that provide precise navigation information for users engaged in backcountry hunting, hiking, or fishing activities across diverse property ownership categories and regulatory environments. The “Property and WMA Info” layer may provide access to property boundary information, Wildlife Management Area designations, and regulatory zone data that ensures users remain within approved hunting areas and comply with local regulations and restrictions applicable to different land ownership types. In some preferred embodiments, the layers menu may support multiple simultaneous layer activation, allowing users to combine different visualization modes such as satellite imagery with topographic overlays for comprehensive geographic information display that facilitates monitoring user activity in private and public outdoor activity areas while maintaining awareness of property boundaries and regulatory compliance requirements.

The user interface 411 may include a close button positioned in the top right corner of the layers panel that enables users to dismiss the menu overlay and return to standard map navigation functionality while maintaining their selected layer configurations for continued outdoor recreation activities. The map view positioned behind the layers overlay may show geographical features and location markers that remain visible during layer selection, ensuring that users maintain spatial awareness while customizing their map visualization preferences for monitoring user activity in private and public outdoor activity areas. In a preferred embodiment, the system 400 may include navigation controls visible on the right side of the screen that provide zoom, pan, and orientation capabilities for detailed map exploration and navigation during outdoor recreation activities conducted across various property types and regulatory jurisdictions. The processor 220 may coordinate layer rendering with GPS device 407 data to ensure that selected map layers accurately reflect the user's current location and surrounding geographic features in real-time, enabling the generation of safety alerts as computer readable signals transmitted to computing devices in the form of messages that notify users about location-specific safety considerations and regulatory requirements. The layers menu interface may support touch-based interaction that allows users to quickly select and deselect different visualization options while maintaining ease of use during outdoor activities when users may be wearing gloves or operating devices in challenging environmental conditions encountered on both private hunting preserves and public wildlife management areas. In some preferred embodiments, the system 400 may provide automatic layer recommendations based on the user's current activity type, with hunting activities defaulting to terrain and property information layers while fishing activities may emphasize satellite and topographic visualization options tailored to the specific requirements of different outdoor recreation scenarios and property ownership categories.

The system 400 may implement a web-based Super Admin Panel that provides management and oversight capabilities for the geographic information system interface and map layer functionality used for monitoring user activity in private and public outdoor activity areas. The Super Admin Panel may enable administrators to manage map-related content, update layer information, and ensure that geographic data remains current and accurate for all system users engaged in outdoor recreational activities across diverse property types and regulatory environments. In a preferred embodiment, the web-based control panel may allow administrators to add new map layers, modify existing layer configurations, and remove outdated geographic information to maintain the accuracy and relevance of the mapping system while ensuring compliance with property boundaries and regulatory requirements applicable to different land ownership categories. The Super Admin Panel may include content management capabilities that allow administrators to update property boundary information, Wildlife Management Area designations, and regulatory zone data in real-time to ensure users have access to current legal and safety information necessary for conducting outdoor recreation activities on both private hunting properties and public recreation areas. The processor 220 may execute instructions stored on the non-transitory computer-readable medium 416 to coordinate between the Super Admin Panel and the user interface 411, ensuring that administrative updates to map layers are immediately reflected in the mobile application interface and can trigger safety alerts as computer readable signals transmitted to computing devices in the form of messages that notify users about updated regulatory information and property boundary changes. The web-based admin panel may provide tools for managing the quality and resolution of satellite imagery, terrain data, and topographic information to optimize map rendering performance across different device types and network conditions while maintaining the accuracy needed for effective monitoring of user activity in private and public outdoor activity areas.

In another preferred embodiment, the Super Admin Panel may include content management system features that enable administrators to add, update, or delete content within the layers menu interface, ensuring that users have access to the most current and accurate geographic information available for outdoor recreational activities conducted on private and public lands. The content management capabilities may allow administrators to modify layer descriptions, update geographic data sources, and configure layer availability based on geographic regions or user subscription levels while maintaining the functionality needed for effective monitoring of user activity in private and public outdoor activity areas. The web-based admin panel may provide analytics and usage tracking capabilities that enable administrators to monitor which map layers are most frequently used by different user groups, allowing for optimization of system resources and user interface design tailored to the specific needs of outdoor recreation participants operating across diverse property types and regulatory jurisdictions. In some preferred embodiments, the Super Admin Panel may include automated content update capabilities that synchronize with government databases, wildlife management agencies, and geographic information providers to ensure that property boundaries, hunting regulations, and Wildlife Management Area information remain current without manual administrative intervention, notifying users about regulatory changes and updated safety requirements. The processor 220 may store administrative changes and content updates within the database 115, ensuring that all modifications to map layers and geographic information are properly logged and can be audited for system maintenance and regulatory compliance purposes applicable to outdoor recreation activities conducted on both private hunting preserves and public wildlife management areas. The web-based admin panel may support role-based access controls that allow different levels of administrative users to manage specific aspects of the geographic information system while maintaining security and preventing unauthorized modifications to geographic data and layer configurations used for monitoring user activity in private and public outdoor activity areas across various property ownership categories and regulatory frameworks.

As illustrated in FIG. 11, the system 400 may implement a comprehensive measurements menu interface that provides users with advanced spatial analysis and navigation tools for precise outdoor recreation planning and safety management across private and public lands. The user interface 411 may display a measurements menu on a mobile device screen that allows users to alter security settings and spatial configurations that may be saved in their user profiles as safety data 430C for monitoring user activity in private and public outdoor activity areas. The user interface 411 may show a map view in the background with a dark overlay panel positioned in the foreground and labeled “Measurements” at the top, providing organized access to various spatial measurement and navigation capabilities while maintaining visibility of underlying geographic features necessary for outdoor recreational activities. In a preferred embodiment, the measurements panel may include several selectable options, including, but not limited to, “Area”, “Track Line”, “Radius”, and “Route guidance/Plotter,” to provide spatial analysis tools for diverse outdoor recreation scenarios conducted on both private hunting preserves and public wildlife management areas. The processor 220 may execute instructions stored on the non-transitory computer-readable medium 416 to manage measurement calculations and route planning functionality, ensuring that users can accurately assess distances, areas, and navigation routes during their outdoor activities as well as notifying users about spatial analysis results and boundary compliance status. The system 400 may store measurement configurations and route preferences within the safety data 430C component of the user profile 430, enabling consistent application of spatial analysis settings across multiple outdoor recreation sessions conducted on various property types and regulatory jurisdictions.

The “Area” measurement option may enable users to calculate the total area of designated hunting zones, fishing areas, or hiking regions by allowing them to define polygon boundaries on the interactive map interface for monitoring user activity in private and public outdoor activity areas. In another preferred embodiment, the area measurement functionality may provide users with precise square footage or acreage calculations that assist in planning hunting strategies, assessing property boundaries, and ensuring compliance with regulatory area restrictions for outdoor recreation activities. The “Track Line” option may enable users to measure linear distances between specific points on the map, providing accurate distance calculations for route planning, safety zone establishment, and navigation reference during outdoor activities as well as notifying users about distance measurements and route compliance. The track line functionality may support multiple waypoint creation, allowing users to measure complex routes that include multiple direction changes and elevation variations commonly encountered in outdoor terrain across diverse property ownership categories. The “Radius” measurement tool may enable users to establish circular measurement areas around specific geographic points, providing capabilities for creating safety zones, determining effective range boundaries, and assessing coverage areas for various outdoor recreation activities conducted on both private hunting properties and public recreation areas. In some preferred embodiments, the radius measurement functionality may integrate with the customizable safety radius features described in previous system components, allowing users to precisely configure safety distances based on specific equipment requirements and environmental conditions while maintaining compliance with property boundaries and regulatory requirements applicable to different land ownership types.

The “Route guidance/Plotter” functionality may provide users with comprehensive navigation assistance that helps users navigate within approved hunting areas or exit them safely through optimized route planning and real-time directional guidance for monitoring user activity in private and public outdoor activity areas. In a preferred embodiment, the route guidance system may analyze terrain features, elevation changes, and geographic obstacles to recommend the most efficient and safe navigation routes for users traveling to specific hunting locations or returning to designated exit points on private and public lands. The route guidance functionality may integrate with the GPS device 407 to provide turn-by-turn navigation instructions that guide users along predetermined routes while maintaining awareness of their current location relative to approved hunting boundaries and safety zones, generating safety alerts as computer readable signals transmitted to computing devices in the form of messages that notify users about navigation progress and boundary proximity. The system 400 may enable users to create custom navigation routes by plotting waypoints and intermediate destinations on the interactive map interface, allowing for personalized route planning that accommodates individual preferences and specific outdoor recreation objectives across diverse property types and regulatory jurisdictions. In another preferred embodiment, the route guidance system may provide alternative route options when primary navigation paths become inaccessible due to environmental conditions, terrain obstacles, or safety considerations that may arise during outdoor recreation activities. The processor 220 may calculate route distances, estimated travel times, and elevation profiles to provide users with comprehensive navigation information that supports informed decision-making during outdoor recreation planning and execution while ensuring compliance with property boundaries and regulatory requirements for different land ownership categories.

The measurements menu interface may enable users to create customizable boundary areas by dropping pins along boundary lines, providing precise tools for establishing geographic limits and safety zones within outdoor recreation areas for monitoring user activity in private and public outdoor activity areas. In a preferred embodiment, users may utilize the measurement tools to define complex boundary configurations that follow natural terrain features, property lines, or regulatory boundaries established by wildlife management agencies and landowners operating across private and public lands. The system 400 may enable users to set predetermined distances for boundary alerts by utilizing the radius and area measurement tools to establish buffer zones around designated boundaries, ensuring that users receive advance warning before approaching restricted areas or safety limits as well as notifying users about boundary proximity and compliance status. The boundary creation functionality may support multiple pin placement options that allow users to create irregular boundary shapes that accurately reflect the geographic realities of their outdoor recreation areas rather than being limited to simple geometric configurations, accommodating the diverse terrain characteristics found on both private hunting properties and public recreation zones. In some preferred embodiments, the measurements menu may provide coordinate display capabilities that show precise latitude and longitude information for each boundary pin, enabling users to record and share exact geographic locations with other outdoor recreation participants and regulatory authorities while maintaining compliance with property boundaries and regulatory requirements applicable to different land ownership types. The processor 220 may store boundary configurations and measurement data within the location data 430B component of user profiles 430, ensuring that customized boundaries and measurement settings are preserved for future outdoor recreation sessions and can be shared with other authorized users engaged in activities across various property ownership categories and regulatory frameworks.

The route guidance functionality may include emergency exit route planning capabilities that automatically identify the shortest and safest paths for users to exit outdoor recreation areas in case of emergencies, adverse weather conditions, or other safety concerns while monitoring user activity in private and public outdoor activity areas. In another preferred embodiment, the route guidance system may integrate with real-time weather data and environmental condition monitoring to provide dynamic route recommendations that account for changing conditions such as flooding, severe weather, or seasonal access restrictions that may affect navigation safety on private and public lands. The system 400 may provide voice-guided navigation instructions through the user interface 411, enabling hands-free operation that allows users to maintain focus on their outdoor activities while receiving navigation guidance through audio prompts and directional instructions, generating safety alerts as computer readable signals transmitted to computing devices in the form of messages that provide navigation updates and safety notifications. The route guidance functionality may include offline mapping capabilities that ensure navigation assistance remains available even when users are operating in remote areas with limited cellular connectivity or internet access, maintaining functionality across diverse outdoor recreation environments regardless of communication infrastructure availability. In some preferred embodiments, the route guidance system may provide estimated battery consumption information for planned routes, helping users manage device power consumption during extended outdoor recreation activities and ensuring that navigation capabilities remain available throughout their planned activities conducted on both private hunting preserves and public wildlife management areas. The processor 220 may coordinate route guidance functionality with the safety alert 409 system to provide integrated navigation and safety monitoring that alerts users when their planned routes may conflict with established safety zones or boundary restrictions applicable to different property types and regulatory jurisdictions.

The measurements menu interface may include precision calibration options that allow users to verify and adjust measurement accuracy based on local geographic conditions and device-specific calibration requirements for monitoring user activity in private and public outdoor activity areas. In a preferred embodiment, the measurement tools may provide multiple unit options, including, but not limited to, metric and imperial measurements, enabling users to work with their preferred measurement systems and ensuring compatibility with local regulatory requirements and mapping standards applicable to private and public lands. The system 400 may enable users to save and name custom measurement configurations, allowing for quick access to frequently used boundary settings, safety radius configurations, and route planning templates during outdoor recreation activities as well as notifying users about saved configuration access and measurement template availability. The measurements menu may include sharing capabilities that allow users to export measurement data, boundary configurations, and route plans to other users or external mapping applications, facilitating coordination among group participants and integration with other outdoor recreation planning tools used across diverse property types and regulatory environments. In some preferred embodiments, the measurement tools may provide area overlap analysis capabilities that identify conflicts between different user boundaries, safety zones, and navigation routes, helping to prevent spatial conflicts and ensure coordinated outdoor recreation activities among multiple participants operating on both private hunting properties and public recreation areas. The processor 220 may generate measurement reports and spatial analysis summaries that can be stored within the user profile 430 and accessed for future reference, regulatory compliance documentation, or sharing with outdoor recreation guides and land management authorities responsible for overseeing activities conducted across various property ownership categories and regulatory frameworks.

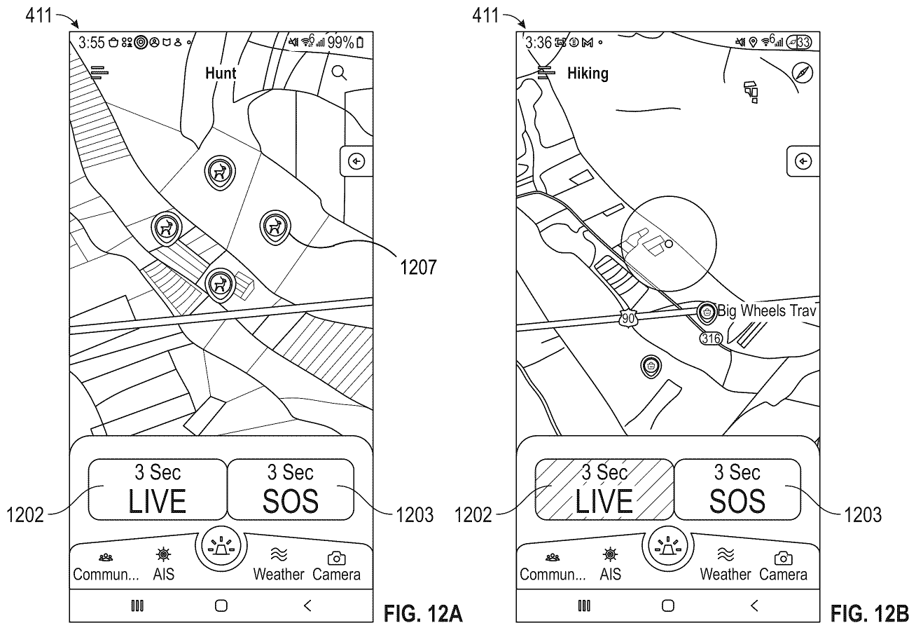

As illustrated in FIG. 12A, the system 400 may implement a comprehensive action button control interface that provides users with centralized access to emergency response and location sharing capabilities during outdoor recreational activities conducted on private and public lands. The user interface 411 may present an interactive map showing an aerial or satellite view of approved hunting areas with terrain features including, but not limited to, buildings, parking areas, vegetation patterns, and topographical elements that enable users to maintain situational awareness while accessing safety controls for monitoring user activity in private and public outdoor activity areas. Multiple location markers may be visible on the map display, indicated by circular icons with distinctive symbols that represent the real-time positions of other users within the designated outdoor recreation area, facilitating coordinated group activities and enhanced safety monitoring across diverse property types and regulatory jurisdictions. The user interface 411 may display a control panel positioned at the bottom portion of the interface that features at least two prominent buttons, including, but not limited to, “LIVE” and “SOS,” for immediate access to location sharing and emergency response functionality during outdoor activities. In some preferred embodiments, the description of the buttons may also include the amount of time required to press the button for activation, with FIGS. 12A-14 illustrating that the buttons require a user 405 to press the button for 3 seconds before activation to prevent accidental triggering during outdoor recreation sessions. In a preferred embodiment, the processor 220 may execute additional instructions stored on the non-transitory computer-readable medium 416 to activate a live mode function that displays real-time locations of hunters to other users, enabling coordinated outdoor recreation activities and enhanced safety monitoring as well as notifying designated contacts about user location sharing status and activity coordination.

The action button control interface may implement a deliberate activation process that requires users to hold an action button for three seconds to display a menu box with live and SOS options, preventing accidental activation while ensuring rapid access during emergency situations encountered during outdoor recreational activities on private and public lands. In another preferred embodiment, a live button 1202 may be displayed within the control panel and may be labeled “LIVE” to indicate the activation duration required for engaging the live mode functionality that enables real-time location sharing among users engaged in hunting, hiking, or fishing activities across diverse property ownership categories. The live button 1202 may enable users to share their real-time location information with other users within the system 400, facilitating coordination and safety monitoring during group outdoor recreation activities as well as notifying other participants about location sharing activation and user availability for collaborative activities. The processor 220 may execute additional instructions stored on the non-transitory computer-readable medium 416 to manage the live mode activation process, wherein the live mode function may be activated by holding the action button for three seconds to display the menu box with live and SOS options, and then holding the live button 1202 for an additional three seconds to complete the activation sequence for monitoring user activity in private and public outdoor activity areas. The system 400 may implement this two-stage activation process to ensure deliberate user intent while providing sufficient time for users to cancel activation if the action button is pressed accidentally during outdoor recreation activities conducted on both private hunting properties and public recreation zones. In some preferred embodiments, the live button 1202 may provide visual feedback during the activation process, displaying countdown indicators or color changes that inform users of the activation progress and remaining hold time required, while simultaneously preparing to generate safety alerts as computer readable signals transmitted to computing devices in the form of messages that will notify other users about the impending location sharing activation.

The pin placement functionality integrates seamlessly with the interactive map interface shown in FIG. 12A, where users can access the mapping features through the user interface 411 displayed on their computing device. The wildlife location markers 1207, as illustrated in FIG. 12A, demonstrate how wildlife observation pins would appear to users 405, providing immediate visual reference points for animal activity locations across the terrain. The system 400 coordinates pin data with the GPS positioning capabilities to ensure accurate geographic placement of wildlife location markers 1207 across the terrain features displayed in the aerial view of FIG. 12A. Users can interact with these virtual pins via the user interface 411, allowing them to view detailed information about each wildlife sighting including species identification, time stamps, and environmental conditions. The pin placement system preferably maintains real-time synchronization with the GPS device 407 to ensure that all wildlife location markers 1207 reflect precise coordinate data for accurate navigation and reference purposes. The interactive nature of the pin placement system enables users 405 to contribute to a collaborative database of wildlife activity patterns while maintaining the safety monitoring capabilities essential for outdoor recreation activities.

In another preferred embodiment, the system 400 may support predator pins that mark locations where users 405 have encountered predator animals, including, but not limited to, bears, mountain lions, wolves, or other potentially dangerous wildlife species (such as wild boar) that pose safety risks to outdoor recreation participants. The predator alert system may be configured to generate safety alerts 409 that warn users 405 when they approach within predetermined distances of marked predator locations based on the user's customizable safety radii. The predator pin functionality utilizes the same interactive mapping interface shown in FIG. 12A, where users can view and place predator warning markers in the form of wildlife location markers 1207 directly on the terrain features visible in the aerial or satellite view. In a preferred embodiment, the control panel at the bottom of the user interface 411 in FIG. 12A provides access to pin placement tools, allowing users 405 to quickly mark predator locations while maintaining access to emergency response features through the live button 1202 and SOS button 1203. The action button, as illustrated in FIG. 12A, may serve as a gateway to advanced pin management features, enabling users 405 to categorize different types of predator encounters and set appropriate warning distances based on the specific threat level and behavior patterns of different predator species. The predator pin system may incorporate proximity monitoring that automatically calculates safe distances based on the type of predator encountered, with larger safety buffers applied for more dangerous species such as bears or mountain lions compared to smaller predators. In some preferred embodiments, the predator warning system may provide differentiated alert levels based on the type of predator, time since the sighting was reported, and environmental conditions that may affect predator behavior patterns in specific geographic areas, with all alert configurations accessible through the user interface 411 mapping system depicted in FIG. 12A. In a preferred embodiment, the system maintains a comprehensive database of predator sightings that can be analyzed to identify seasonal migration patterns, territorial boundaries, and high-risk areas where multiple predator encounters have been reported by different users over time.

As illustrated in FIG. 12B, the user interface 411 may present a map-based display showing a hiking activity, as indicated by the “Hiking” label positioned at the top of the screen, demonstrating the system's capability to support multiple outdoor recreation activity types. The map interface may display geographical features and terrain with a circular overlay indicating a safety radius or monitoring zone centered on a location marker for enhanced spatial awareness during outdoor activities while facilitating monitoring user activity in private and public outdoor activity areas. In a preferred embodiment, the color coding system may provide immediate visual identification of different activity modes and button states, with the blue coloring of the live button 1202 corresponding to hiking activities as established in the system's activity-specific color scheme that differentiates between hunting, hiking, and fishing activities conducted across various property types and regulatory environments. The processor 220 may execute instructions stored on the non-transitory computer-readable medium 416 to coordinate the color coding system with the current activity mode, ensuring that interface elements reflect the appropriate activity type and associated safety protocols while preparing to generate safety alerts as computer readable signals transmitted to computing devices in the form of messages that notify users about activity-specific safety considerations and regulatory compliance requirements. In a preferred embodiment, the centrally located action button may be depicted as a color-coded circular element with a distinctive symbol positioned between and below the live button 1202 and SOS button 1203, providing a prominent visual indicator for emergency response access that remains consistent across all outdoor recreation activity types and property ownership categories.

The system 400 may implement a comprehensive live mode functionality that enables users to control their visibility to other users within the outdoor recreation network through the live button 1202 interface, providing granular privacy management for activities. In another preferred embodiment, the processor 220 may execute additional instructions stored on the non-transitory computer-readable medium 416 to deactivate the live mode function to make hunters no longer visible to other users, providing privacy control and location sharing management capabilities as well as notifying designated contacts about location sharing deactivation and privacy status changes. The live mode deactivation process may follow the same deliberate activation sequence, requiring users to hold the action button for three seconds to display the menu box with live and SOS options, and then hold the live button 1202 for an additional three seconds to deactivate the live mode function, ensuring consistent user interface behavior across all system operations for monitoring user activity in private and public outdoor activity areas. The system 400 may provide visual confirmation of live mode status through the user interface 411, with the live button 1202 displaying different colors or indicators to show whether live mode is currently active or inactive, enabling users to maintain awareness of their location sharing configuration during outdoor recreation activities conducted across diverse property types and regulatory jurisdictions. The processor 220 may store live mode preferences and activation history within the safety data 430C component of the user profile 430, enabling users to review their location sharing activity and maintain control over their privacy settings while supporting record-keeping for outdoor recreation safety management and regulatory compliance purposes. In some preferred embodiments, the live mode functionality may include automatic deactivation timers that disable location sharing after predetermined periods, ensuring that users do not inadvertently continue sharing their location information beyond their intended outdoor recreation activities as well as notifying users about automatic deactivation events and privacy protection measures.

The action button control interface may provide seamless integration with the interactive map display, allowing users to access live mode and emergency response capabilities while maintaining full visibility of their geographic surroundings and the positions of other users engaged in outdoor recreational activities on private and public lands. In a preferred embodiment, the user interface 411 may display the live button 1202 and SOS button 1203 as overlay elements that do not obstruct the underlying map information, ensuring that users can simultaneously monitor their spatial environment and access safety controls while conducting activities for monitoring user activity in private and public outdoor activity areas. The system 400 may implement touch-responsive interface elements that provide tactile feedback when users interact with the live button 1202, action button, and SOS button 1203, ensuring reliable operation even when users are wearing gloves or operating devices in challenging environmental conditions commonly encountered during outdoor recreation activities across diverse terrain types and weather conditions. The processor 220 may coordinate the action button control interface with the GPS device 407 to ensure that live mode activation immediately begins transmitting accurate location information to other users within the network 150 so that the system 400 might notify recipients about real-time location sharing initiation and user availability for coordination activities. The live mode functionality may include customizable sharing preferences that allow users to control which other users can view their real-time location information, providing granular privacy controls while maintaining the collaborative benefits of location sharing during outdoor recreation activities conducted on both private hunting properties and public recreation areas. In some preferred embodiments, the action button control interface may include voice confirmation capabilities that provide audio feedback when live mode is activated or deactivated, ensuring that users receive clear confirmation of their location sharing status even when visual attention is focused on outdoor recreation activities rather than the device display, while simultaneously generating safety alerts as computer readable signals transmitted to computing devices in the form of messages that provide audio confirmation notifications to designated monitoring contacts about user location sharing status changes.

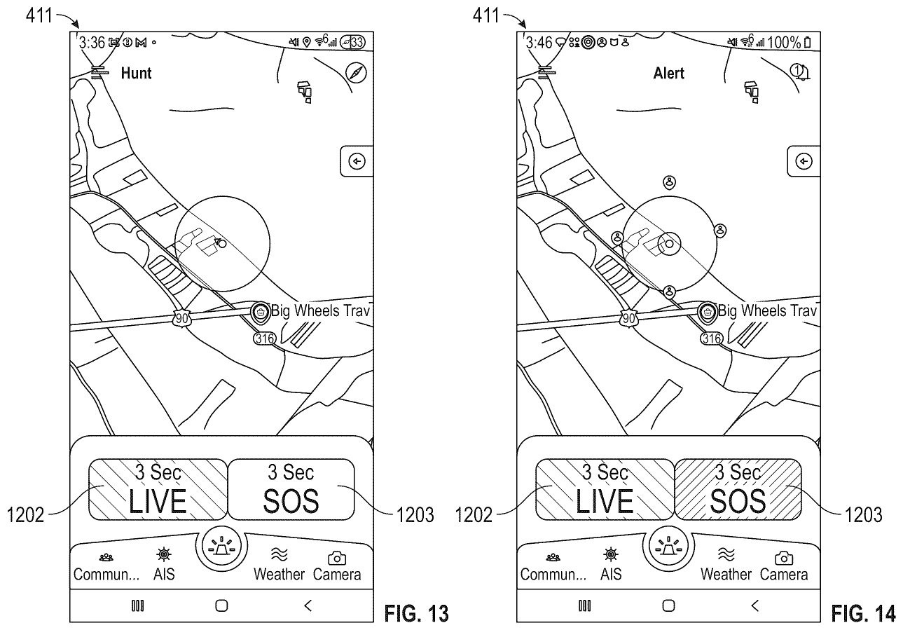

As illustrated in FIG. 13, the system 400 may implement a live mode activation interface that provides visual confirmation and real-time location display capabilities when users engage the live mode functionality for enhanced coordination during outdoor recreational activities. The user interface 411 may display a detailed map depicting terrain features, roads, and geographic elements that provide spatial context for users engaged in hunting activities while monitoring user activity in private and public outdoor activity areas. A location marker may be visible within a circular overlay on the map interface, representing the user's current position and indicating active live mode status to other users within the system 400 network for coordinated safety monitoring across diverse property types. The user interface 411 may display the word “Hunt” in color-coded text at the top of the interface, along with menu and notification icons that provide access to additional system features while maintaining focus on the primary hunting activity mode across various outdoor recreation environments. In a preferred embodiment, the processor 220 may execute additional instructions stored on the non-transitory computer-readable medium 416 to activate a live mode function that displays real-time locations of hunters to other users, enabling coordinated outdoor recreation activities and enhanced safety monitoring across the network 150. The live mode activation may cause immediate changes to the visual appearance of interface elements, providing clear confirmation that location sharing has been successfully initiated and that the user's position is now visible to other authorized users within the outdoor recreation area, including, but not limited to, hunting preserves, fishing locations, and hiking trails on both private and public properties.

The user interface 411 may display a control panel positioned at the bottom portion of the mobile computing device that shows the live button 1202 labeled “LIVE” with a color indicating that the live mode function has been successfully activated and is currently operational for monitoring user activity in private and public outdoor activity areas. The coloring of the live button 1202 may correspond to the color coding of the hunting activity mode as established in the system's color coding scheme, providing immediate visual confirmation of both the active live mode status and the current outdoor recreation activity type conducted across diverse property ownership categories. In another preferred embodiment, the SOS button 1203 may be displayed with a background color and labeled “SOS” that maintains its standby appearance while the live mode function remains active and operational during outdoor activities on private and public lands. The processor 220 may coordinate the color changes of interface elements to ensure that users receive clear visual feedback about their current system status and location sharing configuration so that the system 400 may notify monitoring contacts about live mode activation status. The centrally located action button may be positioned between the live button 1202 and SOS button 1203, providing continued access to emergency response capabilities while the live mode function operates across various outdoor recreation environments. In some preferred embodiments, the action button may also reflect the active live mode status through color changes or visual indicators that correspond to the current activity mode and location sharing configuration, ensuring consistent user interface behavior across different outdoor recreation scenarios, including, but not limited to, hunting expeditions, fishing activities, and hiking adventures conducted on both private hunting preserves and public wildlife management areas.

The system 400 may implement dynamic color coordination between the live button 1202 and the safety radius display to provide consistent visual indicators of active live mode status across all interface elements while monitoring user activity in private and public outdoor activity areas. The circular overlay displayed on the map interface may utilize the same coloring as the live button 1202, creating a cohesive visual system that enables users to immediately understand their current location sharing status and activity mode configuration during outdoor recreation activities. In a preferred embodiment, the processor 220 may execute instructions stored on the non-transitory computer-readable medium 416 to ensure that the safety radius display changes color to match the activated live button 1202, providing visual consistency that helps users maintain awareness of their active status regardless of which screen they are viewing throughout the application and notifies other users about live mode status changes. The coloring of both the live button 1202 and the safety radius overlay may serve as a continuous visual reminder that the user's location is currently being shared with other users within the system 400 across diverse outdoor recreation environments, including, but not limited to, private hunting properties and public recreation areas. The color coordination system may extend to other interface elements including navigation icons, status indicators, and map overlays to ensure that users always know if they are in live mode regardless of what screen they are using throughout the application during activities conducted across various property types and regulatory jurisdictions. In some preferred embodiments, the system 400 may provide additional visual indicators such as pulsing effects or animated elements that further emphasize the active live mode status and ensure that users remain aware of their location sharing configuration while engaging in outdoor recreational activities.

The live mode activation interface may provide users with control over their location sharing preferences and visibility settings through the display 316 of the user interface 411 while monitoring user activity in private and public outdoor activity areas. The processor 220 may manage the live mode function to ensure that real-time location data from the GPS device 407 is continuously transmitted through the network 150 to other authorized users within the outdoor recreation area, enabling coordinated activities on private and public lands. In another preferred embodiment, the system 400 may enable users to monitor which other users can currently view their real-time location information, providing transparency and control over location sharing relationships during outdoor recreation activities and notifying users about location visibility status and authorized viewer access. The live mode function may include automatic status updates that inform other users when someone joins or leaves the active location sharing network, enabling coordinated group activities and enhanced situational awareness among outdoor recreation participants operating across various property types and regulatory environments. The user interface 411 may display location markers for other users who have also activated their live mode functions, creating a comprehensive real-time map of all active participants within the outdoor recreation area, including, but not limited to, hunters, hikers, and fishing enthusiasts engaged in activities on both private hunting properties and public recreation zones. The processor 220 may store live mode activation data within the safety data 430C component of the user profile 430, enabling users to review their location sharing history and maintain control over their privacy preferences across multiple outdoor recreation sessions conducted on diverse property types and regulatory jurisdictions.

The system 400 may implement a comprehensive deactivation process that allows users to disable the live mode function and make their location no longer visible to other users through the same deliberate interface controls used for activation while monitoring user activity in private and public outdoor activity areas. In a preferred embodiment, the live mode deactivation process may require users to hold the action button down for 3 seconds to display the menu box with live and SOS options, and then hold the live button 1202 for an additional 3 seconds to deactivate the live mode function during outdoor recreation activities. The processor 220 may execute additional instructions stored on the non-transitory computer-readable medium 416 to deactivate the live mode function to make hunters no longer visible to other users, providing privacy control and location sharing management capabilities when users complete their outdoor recreation activities or require privacy for specific portions of their activities across diverse property types and regulatory environments. The deactivation process may cause immediate visual changes to the user interface 411, with the live button 1202 returning to its inactive color scheme and the safety radius overlay changing from orange to the default color configuration to notify other users about live mode deactivation and privacy status changes. The system 400 may provide confirmation messages or visual indicators when live mode deactivation is completed, ensuring that users receive clear feedback that their location sharing has been successfully disabled during outdoor recreation activities, including, but not limited to, hunting expeditions, fishing trips, and hiking adventures. In some preferred embodiments, the deactivation process may include automatic cleanup procedures that remove the user's location marker from other users'map displays and update the network 150 to reflect the changed location sharing status across various outdoor recreation environments and property ownership categories.

The live mode activation interface may integrate seamlessly with other system 400 features including emergency response capabilities, boundary monitoring, and collaborative communication tools to provide comprehensive outdoor recreation safety management while monitoring user activity in private and public outdoor activity areas across diverse property ownership categories. The processor 220 may coordinate live mode functionality with the safety alert 409 system to ensure that emergency notifications and proximity alerts remain operational while location sharing is active during outdoor recreation activities. In another preferred embodiment, the live mode function may enhance the effectiveness of the customizable safety radius monitoring by providing other users with real-time visibility of the user's position and associated safety zone boundaries to notify participants about proximity status and safety zone interactions. The system 400 may enable users to customize their live mode preferences including update frequency, visibility duration, and authorized viewer lists to provide granular control over location sharing while maintaining the collaborative benefits of real-time position information across various outdoor recreation environments and regulatory jurisdictions. The live mode activation may trigger automatic notifications to other users within the outdoor recreation area, informing them that additional participants have joined the active location sharing network and are available for coordination and safety monitoring during activities conducted on both private hunting properties and public recreation areas. The user interface 411 may provide battery usage indicators and power management options specifically related to live mode operation, helping users balance location sharing benefits with device power consumption during extended outdoor recreation activities, including, but not limited to, multi-day hunting expeditions, backcountry fishing trips, and extended hiking adventures across diverse terrain types and property boundaries. In some preferred embodiments, the live mode function may include offline capabilities that cache location sharing data when network connectivity is limited, ensuring that location information is transmitted to other users when communication links are reestablished while maintaining continuous safety monitoring across remote outdoor recreation environments on both private hunting preserves and public wildlife management areas.

As illustrated in FIG. 14, the system 400 may implement a comprehensive SOS emergency mode activation interface that provides immediate visual alerts and emergency response coordination when users activate the SOS button 1203 during outdoor recreational activities. The user interface 411 may present a map-based display showing geographical areas with roads, landmarks including “Big Wheels Travel Cent,” and various location markers that provide spatial context for emergency response coordination across diverse outdoor recreation environments. The user interface 411 may display the word “Alert” in color-coded text at the top of the screen, indicating an active emergency alert status and providing immediate visual confirmation that the SOS emergency mode has been successfully activated for monitoring user activity in private and public outdoor activity areas. The map interface may include a central target or location indicator surrounded by a circular safety radius zone rendered in a semi-transparent overlay that helps other users identify the emergency location during hunting, hiking, or fishing activities. Multiple location pin markers may be positioned around the perimeter of the safety radius, representing the positions of other users who can provide assistance during emergency situations encountered in remote wilderness environments. In a preferred embodiment, the processor 220 may execute instructions stored on the non-transitory computer-readable medium 416 to activate the SOS emergency mode when users press the SOS button 1203, which generates safety alerts as computer readable signals transmitted to computing devices in the form of messages that notify nearby hunters and predesignated emergency contacts about the user's location and emergency status.

The user interface 411 may display a control panel positioned at the bottom portion of the interface that features the live button 1202 with an color-coded background displaying “3 Sec” and the text “LIVE” in white lettering, maintaining its previous activity status while the emergency mode operates during outdoor recreational activities. The SOS button 1203 may be displayed with a color-coded background (preferably red) showing “3 Sec” and the text “SOS” in lettering, providing clear visual confirmation that the emergency alert system has been activated and is currently operational for monitoring user activity in private and public outdoor activity areas. In another preferred embodiment, the processor 220 may coordinate the SOS button 1203 activation to cause the action button to blink when the emergency mode is engaged, providing a prominent visual indicator that draws attention to the active emergency status during hunting expeditions, fishing activities, or hiking adventures. The blinking, color-coded action button may serve as a continuous visual alert that ensures users and nearby individuals can immediately identify that an emergency situation is in progress and requires immediate attention across diverse property types and regulatory jurisdictions. The system 400 may implement the color-coded blinking functionality through rapid color alternation or pulsing effects that create a distinctive visual pattern easily recognizable as an emergency indicator that notifies all connected users about the emergency status. In some preferred embodiments, the blinking color-coded action button may be accompanied by additional visual effects including, but not limited to, screen border highlighting or overlay indicators that further emphasize the emergency status across the entire user interface 411 during outdoor recreation activities conducted on private and public lands.

The SOS emergency mode activation may trigger immediate transmission of GPS coordinates from the GPS device 407 through the network 150 to nearby users and predesignated emergency contacts, ensuring rapid mobilization of assistance during outdoor recreation emergencies encountered on both private hunting properties and public recreation areas. In a preferred embodiment, the processor 220 may execute additional instructions stored on the non-transitory computer-readable medium 416 to display the GPS coordinates and safety radius of an emergency user as color-coded indicators to help other users locate the emergency user during response efforts while monitoring user activity in private and public outdoor activity areas. The safety radius of the emergency user may be rendered in color-coded coloring on the interactive maps viewed by other users, creating a distinctive visual marker that enables rapid identification and navigation to the emergency location during hunting, hiking, or fishing activities across diverse property ownership categories. The color-coded safety radius display may override the normal activity-based color coding system during emergency situations, ensuring that the emergency location receives visual priority over other system indicators and map elements that provide emergency location information. The system 400 may transmit precise GPS coordinates along with the color-coded safety radius information to all nearby users within the network 150, enabling coordinated emergency response efforts and ensuring that multiple users can navigate to the emergency location simultaneously across various outdoor recreation environments. The processor 220 may store emergency alert data within the safety data 430C component of the user profile 430, creating a record of emergency activations and response times for analysis and system improvement purposes applicable to outdoor recreation activities.

The emergency alert system may provide comprehensive notification capabilities that extend beyond the immediate outdoor recreation area to include predesignated emergency contacts stored within the user profile 430 for monitoring user activity. In another preferred embodiment, the SOS button 1203 activation may trigger automatic communication with emergency contacts through multiple channels including, but not limited to, SMS, email, and phone calls to ensure that assistance can be mobilized even if nearby users are unable to respond immediately during outdoor recreation activities. The system 400 may include customizable emergency contact lists that allow users to specify different types of contacts for different emergency scenarios, enabling targeted response based on the nature of the emergency situation encountered during hunting expeditions, fishing trips, or hiking adventures on both private hunting preserves and public wildlife management areas. The processor 220 may coordinate emergency alert transmission to ensure that both nearby users within the system 400 and external emergency contacts receive simultaneous safety alerts as computer readable signals transmitted to computing devices in the form of messages that notify recipients about the emergency situation and precise location information. The emergency alert notifications may include detailed information about the user's location, current activity type, and any additional context information that may assist emergency responders in providing appropriate assistance during outdoor recreation emergencies. In some preferred embodiments, the emergency alert system may include automatic escalation procedures that contact additional emergency services if initial alerts are not acknowledged within predetermined time intervals, ensuring comprehensive emergency response coverage for activities.

The SOS emergency mode interface may provide other users with enhanced navigation and location assistance capabilities that facilitate rapid response to emergency situations encountered during outdoor recreational activities conducted across various property ownership categories and regulatory environments. The color-coded safety radius display may serve as a visual beacon that guides responding users to the emergency location while providing clear indication of the affected area and potential hazards during hunting, hiking, or fishing activities on both private hunting properties and public recreation areas. In a preferred embodiment, the system 400 may provide responding users with turn-by-turn navigation instructions that guide them along the most efficient routes to reach the emergency location based on current terrain conditions and accessibility factors while monitoring user activity in private and public outdoor activity areas. The processor 220 may analyze the positions of all nearby users and may provide coordinated response recommendations that optimize the deployment of available assistance resources during emergency situations, generating safety alerts as computer readable signals transmitted to computing devices in the form of messages that coordinate response efforts. The emergency mode interface may include communication capabilities that allow responding users to coordinate their assistance efforts and share information about their approach routes and estimated arrival times. The system 400 may enable the emergency user to provide additional information about their situation through the user interface 411, allowing them to specify the type of assistance needed and any relevant medical or safety considerations that may affect the response effort conducted on private and public lands.

The SOS emergency mode may include deactivation procedures that allow users to safely disable the emergency alert system once the emergency situation has been resolved or assistance has arrived during outdoor recreational activities. In another preferred embodiment, the deactivation process may follow the same deliberate activation sequence used for SOS activation, requiring users to hold the action button down for 3 seconds to display the menu box with live and SOS options, and then hold the SOS button 1203 for an additional 3 seconds to deactivate the SOS emergency mode while monitoring user activity in private and public outdoor activity areas. The processor 220 may execute additional instructions stored on the non-transitory computer-readable medium 416 to manage the SOS deactivation process and ensure that emergency alerts are properly cancelled when the situation is resolved, generating safety alerts as computer readable signals transmitted to computing devices in the form of messages that notify all connected users about the deactivation status. The deactivation process may trigger immediate visual changes to the user interface 411, with the SOS button 1203 returning to its inactive color-coded background (preferably grey) and the action button ceasing its color-coded blinking pattern during outdoor recreation activities across diverse property ownership categories. The system 400 may provide confirmation messages or visual indicators when SOS deactivation is completed, ensuring that users receive clear feedback that their emergency alert has been successfully disabled and that normal system operation has been restored for activities conducted on private and public lands. In some preferred embodiments, the deactivation process may include automatic notification to responding users and emergency contacts, informing them that the emergency situation has been resolved and that response efforts can be discontinued through safety alerts transmitted as computer readable signals to computing devices in the form of messages that provide resolution confirmation.

The SOS emergency mode deactivation may restore the previous activity color coding system that was in effect before the emergency alert was activated, ensuring seamless transition back to normal outdoor recreation monitoring and safety features. In a preferred embodiment, the processor 220 may execute instructions to return the user's safety radius and activity button to the previous selected activity color once the SOS emergency mode has been deactivated while monitoring user activity in private and public outdoor activity areas. In a preferred embodiment, the system 400 may restore the original activity-based color scheme including, but not limited to, orange for hunting activities, blue for hiking activities, and yellow for fishing activities, depending on the user's activity mode that was active before the emergency situation occurred. The deactivation process may also restore the live mode functionality to its previous operational status, enabling users to continue sharing their location information with other users if the live mode was active before the emergency alert was triggered. The processor 220 may coordinate the color restoration process to ensure that all interface elements including the action button, safety radius display, and activity indicators return to their appropriate colors based on the user's current outdoor recreation activity. In some preferred embodiments, the system 400 may provide a brief transition period during deactivation where interface elements gradually change from emergency color-coded coloring back to the normal activity colors, providing visual confirmation of the successful emergency mode deactivation process for outdoor recreation activities.

In a preferred embodiment, the system 400 may implement fishing interface integration capabilities that extend the outdoor recreation safety and communication platform to support aquatic activities and marine environments for monitoring user activity in private and public outdoor activity areas. The fishing interface module may provide location selection functionality that enables users to manually select their fishing locations or use GPS technology to find nearby fishing spots such as lakes, rivers, or oceans. The processor 220 may execute instructions stored on the non-transitory computer-readable medium 416 to integrate with mapping services and geographic databases that contain information about fishing locations, access points, and aquatic environments suitable for recreational fishing activities. The fishing interface may enable users to identify and navigate to nearby fishing spots using GPS-integrated maps that display detailed information about water bodies, shoreline access, and fishing regulations specific to each location to notify users about location-specific safety considerations. The system 400 may store fishing location preferences and historical fishing spot data within the location data 430B component of user profiles 430, enabling users to quickly access their preferred fishing locations and maintain records of successful fishing areas across diverse property ownership categories. In another preferred embodiment, the fishing interface module may provide comprehensive fish species identification capabilities that include detailed profiles of local fish species with information about behavior, habitat preferences, and recommended bait and techniques for improving fishing success while maintaining compliance with regulations applicable to different land ownership types.

In a preferred embodiment, the system 400 may implement weather forecast integration that provides real-time updates on temperature, wind speed, and precipitation for selected fishing locations and outdoor recreation areas for monitoring user activity in private and public outdoor activity areas. In a preferred embodiment, the weather forecasting functionality may integrate with meteorological services and weather data providers to deliver current conditions and extended forecasts that enable users to plan their outdoor activities more effectively. The processor 220 may execute additional instructions stored on the non-transitory computer-readable medium 416 to retrieve and display weather information including, but not limited to, temperature ranges, wind direction and speed, precipitation probability, and sunrise and sunset times for specific geographic locations. The weather forecast integration may provide hourly and daily weather predictions that allow users to optimize their fishing and hunting schedules based on environmental conditions that affect wildlife behavior and outdoor activity success across various property types and regulatory jurisdictions. The system 400 may enable users to set weather-based alerts and notifications that inform them of favorable conditions for their preferred outdoor activities or warn them of adverse weather that may pose safety risks in order to notify users about weather-related safety considerations. In some preferred embodiments, the weather forecast integration may include specialized marine weather information for users engaged in fishing activities, providing data about wave heights, water temperature, and tidal information that affects fishing success and safety on water bodies.

In another preferred embodiment, the system 400 may implement equipment checklist functionality that provides reminders for essential items needed for outdoor activities and ensures users are properly prepared for their recreational pursuits while monitoring user activity in private and public outdoor activity areas. The equipment checklist feature may enable users to create and manage customized checklists for different types of outdoor activities including, but not limited to, hunting, fishing, hiking, and camping, with each checklist containing items specific to the requirements and safety considerations of each activity. The processor 220 may execute instructions stored on the non-transitory computer-readable medium 416 to manage equipment checklist creation, modification, and reminder functionality that helps users avoid forgetting gear and supplies to notify users about equipment preparation status. The equipment checklist may include categories for safety equipment, navigation tools, communication devices, weather protection, food and water supplies, and activity-specific gear such as firearms, fishing tackle, or hiking equipment tailored to the specific requirements of different outdoor recreation environments. The system 400 may provide reminder notifications that alert users about checklist items before their planned outdoor activities, enabling them to verify that all necessary equipment has been gathered and prepared for activities. The equipment checklist functionality may integrate with the user profile 430 to store personalized equipment preferences and may learn from user behavior to suggest additional items based on the specific locations, weather conditions, and activity types planned for each outdoor recreation session.

The system 400 may implement comprehensive catch log functionality that enables users to document fishing trips with detailed information about species, size, weight, and time details for comprehensive record-keeping and analysis of fishing activities conducted for monitoring user activity in private and public outdoor activity areas. In a preferred embodiment, the catch log may serve as a digital fishing journal that helps users track their progress and experiences over time while building a database of fishing success patterns and environmental conditions. The processor 220 may execute additional instructions stored on the non-transitory computer-readable medium 416 to manage catch log data entry, storage, and analysis functionality that enables users to record detailed information about each fish caught during their fishing activities on both private and public lands. The catch log functionality may enable users to document catch details including, but not limited to, fish species identification, measurements such as length and weight, time and date of catch, location coordinates from the GPS device 407, weather conditions, bait or lure used, and photographic documentation of the catch as well as notify designated contacts about user activity status. The system 400 may store catch log data within the image data 430D and user data 430A components of user profiles 430, enabling long-term tracking of fishing success and analysis of patterns that contribute to successful fishing outcomes across diverse outdoor recreation environments. The catch log may include sharing capabilities that allow users to share their fishing achievements with other users through the social media feed interface, contributing to the collaborative knowledge base of the outdoor recreation community while maintaining compliance with regulations applicable to different property types and regulatory jurisdictions.

In another preferred embodiment, the system 400 may implement comprehensive Automatic Identification System integration for vessel tracking and maritime safety alerts that enhance safety for users engaged in water-based outdoor recreation activities while monitoring user activity in private and public outdoor activity areas. The AIS integration may enable users to view nearby vessels in real-time using AIS data transmitted by commercial and recreational vessels operating in their fishing areas on both private waterfront properties and public marine areas managed by state and federal agencies. The processor 220 may execute instructions stored on the non-transitory computer-readable medium 416 to receive and process AIS data that provides information about vessel positions, speeds, courses, and identification details for maritime traffic in the vicinity of fishing activities as well as notify users about vessel proximity and potential navigation hazards. The AIS integration may help users avoid congested areas or navigate around commercial shipping lanes, enhancing safety during fishing trips and reducing the risk of collisions or interference with commercial maritime operations across diverse water body ownership categories. The system 400 may provide safety alerts and notifications that warn users of approaching large vessels or potential hazards based on AIS data analysis and proximity calculations conducted in real-time during outdoor recreation activities. The AIS integration may display detailed information about nearby vessels including, but not limited to, vessel name, size, type, speed, and course information that helps users identify potential sources of disturbance during their fishing activities on private and public waterways.

The system 400 may implement regulations and licensing information capabilities that provide users with current legal requirements and compliance information for their outdoor recreation activities conducted for monitoring user activity in private and public outdoor activity areas. In a preferred embodiment, the regulations and licensing system may provide information on fishing regulations and licensing requirements for chosen locations through hyperlinks and downloadable content that ensures users are aware of and comply with applicable legal guidelines. The processor 220 may execute additional instructions stored on the non-transitory computer-readable medium 416 to access and display current regulatory information including, but not limited to, fishing limits, seasonal restrictions, licensing requirements, and area-specific regulations that affect outdoor recreation activities across diverse property ownership categories. The regulations and licensing information system may integrate with government databases and wildlife management agencies to provide up-to-date information about hunting seasons, bag limits, permit requirements, and restricted areas that users must observe during their outdoor activities to notify users about regulatory compliance requirements. The system 400 may enable users to access downloadable content including regulation summaries, permit applications, and compliance checklists that facilitate adherence to legal requirements for outdoor recreation activities conducted on both private hunting properties and public recreation areas. The regulations and licensing information may be stored within the user data 430A component and may be integrated with the digital wallet functionality to provide centralized access to both regulatory information and required documentation across various outdoor recreation environments and regulatory jurisdictions.

In another preferred embodiment, the system 400 may implement comprehensive third-party integration capabilities with payment gateways, analytics tools, and other relevant systems that extend the functionality and commercial viability of the outdoor recreation safety platform for monitoring user activity. The third-party integration capabilities may enable the system 400 to connect with external services and platforms that enhance user experience and provide additional functionality beyond the core safety and communication features for activities. The processor 220 may execute instructions stored on the non-transitory computer-readable medium 416 to manage third-party integration protocols and data exchange with external systems including, but not limited to, payment processing services, analytics platforms, and outdoor recreation service providers in a way that notifies users about integration status and service availability. The payment gateway integration may enable users to purchase premium features, subscription services, and outdoor recreation products directly through the system 400 interface, providing convenient access to enhanced functionality and related services across diverse outdoor recreation environments. The analytics tools integration may provide enhanced data analysis capabilities that extend beyond the built-in reporting features to include advanced statistical analysis, predictive modeling, and business intelligence capabilities for system administrators and commercial partners operating across various property types and regulatory frameworks. The system 400 may support integration with outdoor recreation service providers including hunting guides, fishing charters, equipment rental services, and accommodation providers to create an ecosystem of outdoor recreation services applicable to both private hunting preserves and public wildlife management areas.

In yet another preferred embodiment, the system 400 may implement user support management tools that enable administrators to view, respond to, and resolve user-reported issues through systematic customer service and technical support processes for monitoring user activity. In a preferred embodiment, the user support management system may provide administrators with centralized access to user inquiries, technical problems, feature requests, and feedback submissions through the web-based Super Admin Panel interface for activities. The processor 220 may execute additional instructions stored on the non-transitory computer-readable medium 416 to manage user support ticket creation, assignment, tracking, and resolution processes that ensure responsive customer service and system maintenance. The user support management tools may enable administrators to categorize user issues by type, priority level, and complexity to ensure that support resources are allocated efficiently and that safety-related issues receive immediate attention. The system 400 may provide communication tools that enable support staff to respond to user inquiries through multiple channels including, but not limited to, email, in-app messaging, and phone support, ensuring that users can receive assistance through their preferred communication methods regardless of their location on private or public outdoor recreation areas. The user support management system may include knowledge base integration that provides support staff with access to common solutions, troubleshooting guides, and system documentation that enables efficient resolution of user issues.

In another preferred embodiment, the system 400 may implement advertisement management capabilities that enable administrators to monitor ad revenue and track ad performance for commercial monetization of the outdoor recreation safety platform. The advertisement management system may provide tools for managing ad placement, performance monitoring, and revenue optimization within the mobile application and web-based interfaces for activities. The processor 220 may execute instructions stored on the non-transitory computer-readable medium 416 to coordinate advertisement display, user interaction tracking, and performance analytics that support commercial advertising operations that notify administrators about advertising performance metrics and revenue status. The advertisement management capabilities may enable administrators to configure ad placement locations within the user interface 411, set targeting parameters based on user demographics and activity preferences, and monitor click-through rates and engagement metrics for advertising campaigns. The system 400 may support various advertisement formats including, but not limited to, banner ads, interstitial ads, video advertisements, and sponsored content that can be integrated seamlessly with the outdoor recreation safety features without compromising user experience or safety functionality. The advertisement management system may include revenue tracking and reporting capabilities that provide detailed analytics about advertising performance, user engagement, and financial returns from advertising partnerships applicable to both private hunting properties and public recreation areas.

In yet another preferred embodiment, the system 400 may implement reporting and analytics tools that provide administrators with capabilities for generating insights from user data and behavior patterns to support system optimization and business decision-making. In a preferred embodiment, the analytics reporting tools may enable administrators to analyze user activity patterns, feature utilization, geographic usage distribution, and safety event frequency to identify trends and opportunities for system improvement across private and public lands. The processor 220 may execute additional instructions stored on the non-transitory computer-readable medium 416 to collect, process, and analyze user data while maintaining privacy protection and data security standards that comply with applicable regulations and user consent requirements. The reporting and analytics tools may provide customizable dashboard interfaces that enable administrators to monitor key performance indicators including, but not limited to, user engagement, safety alert frequency, emergency response times, and system reliability metrics. The system 400 may generate automated reports that summarize user activity, system performance, and safety outcomes on daily, weekly, monthly, and annual intervals to support ongoing system management and improvement initiatives. The analytics tools may include predictive analysis capabilities that identify potential safety risks, usage patterns, and system capacity requirements based on historical data and trend analysis conducted across various outdoor recreation scenarios and regulatory jurisdictions.

The analytics reporting system may enable administrators to analyze the effectiveness of safety features including, but not limited to, proximity alert response rates, emergency response times, and user compliance with safety protocols to identify areas for system enhancement and user education for monitoring user activity in outdoor activity areas. In another preferred embodiment, the analytics tools may provide geographic analysis capabilities that identify high-risk areas, popular outdoor recreation locations, and regional usage patterns that inform safety protocol development and resource allocation decisions. The processor 220 may coordinate data collection from multiple system components including the GPS device 407, safety alert 409, user interface 411 interactions, and communication activities to provide comprehensive analytics that reflect all aspects of user behavior and system performance. The reporting tools may include user behavior analysis that identifies common usage patterns, feature preferences, and safety practices among different user demographics to support targeted system improvements and user education initiatives. The system 400 may provide benchmarking capabilities that compare safety outcomes, user engagement, and system performance against industry standards and best practices for outdoor recreation safety management. The analytics reporting tools may include real-time monitoring capabilities that enable administrators to identify and respond to system issues, safety concerns, and user support needs as they occur, ensuring proactive system management and user safety protection across various outdoor recreation scenarios and regulatory frameworks.

The method for managing hunter safety in approved hunting areas may comprise steps of determining real-time geolocations of multiple hunters using GPS technology through systematic location tracking and monitoring processes that ensure comprehensive spatial awareness during outdoor recreation activities for monitoring user activity in private and public outdoor activity areas. The method may utilize GPS technology to continuously monitor and update the positions of multiple hunters within designated outdoor recreation areas, providing the foundational location data required for proximity monitoring, boundary compliance, and emergency response coordination on both private and public lands. The GPS technology implementation may involve continuous polling of satellite positioning systems to maintain accurate and current location information for all active users within the outdoor recreation safety network in order to notify designated contacts about user location status and movement patterns. The method may include steps of processing GPS coordinate data to calculate relative positions between multiple hunters and to determine when safety thresholds are approached or exceeded based on predetermined proximity limits and safety radius configurations across diverse property ownership categories and regulatory jurisdictions. The real-time geolocation determination process may involve coordinate system conversions, accuracy validation, and error correction procedures that ensure reliable location data for safety monitoring and emergency response applications conducted on both private hunting preserves and public wildlife management areas. The method may implement location data filtering and smoothing algorithms that reduce GPS signal noise and provide stable position tracking even in challenging environmental conditions such as dense forest cover or mountainous terrain that may interfere with satellite signal reception across various outdoor recreation environments.

In a preferred embodiment, the system 400 may use artificial intelligence (AI) techniques to perform functions of the outdoor recreation safety and communication system. In one preferred embodiment, AI techniques may be used to optimize the presentation of safety information and location data within the user interface 411. In another preferred embodiment, AI techniques may be used to organize and prioritize safety alerts and proximity notifications based on user activity patterns and environmental conditions. In yet another preferred embodiment, AI techniques may be used to evaluate location data 430B and safety data 430C collected by the system to assist users in making informed decisions about outdoor recreation activities and route planning. In yet another preferred embodiment, AI techniques may be used by the system 400 to determine when a user 405 is experiencing an emergency situation or requires immediate assistance based on GPS tracking patterns and check-in timer 504 violations. In yet another preferred embodiment, AI techniques may be used to monitor and predict weather conditions and environmental hazards that may affect outdoor recreation safety. In yet another preferred embodiment, the AI techniques may be used to create optimized hunting strategies and suggest ideal locations based on historical animal sighting data and environmental factors. The term “artificial intelligence” and grammatical equivalents thereof are used herein to mean an intelligence method used by the system 400 to correctly interpret and learn from data of the system 400 or a plurality of systems in order to achieve specific goals and tasks through flexible adaptation. Types of intelligence methods that may be used by the system 400 include, but are not limited to, machine learning, neural network, computer vision, or any combination thereof.

The system 400 preferably uses machine learning techniques to perform the methods disclosed herein, wherein the instructions carried out by the processor 220 for said machine learning techniques are stored on the non-transitory computer-readable medium 416, server 110, and/or database 115. Machine learning techniques that may be used by the system 400 include, but are not limited to, classification algorithms, neural network algorithm, regression algorithms, decision tree algorithms, clustering algorithms, genetic algorithms, supervised learning algorithms, semi-supervised learning algorithms, unsupervised learning algorithms, deep learning algorithms, or other types of algorithms. More specifically, machine learning algorithms can include implementations of one or more of the following algorithms: support vector machine, decision tree, nearest neighbor algorithm, random forest, ridge regression, Lasso algorithm, k-means clustering algorithm, boosting algorithm, spectral clustering algorithm, mean shift clustering algorithm, non-negative matrix factorization algorithm, elastic net algorithm, Bayesian classifier algorithm, RANSAC algorithm, orthogonal matching pursuit algorithm, bootstrap aggregating, temporal difference learning, backpropagation, online machine learning, Q-learning, stochastic gradient descent, least squares regression, logistic regression, ordinary least squares regression (OLSR), linear regression, stepwise regression, multivariate adaptive regression splines (MARS), locally estimated scatterplot smoothing (LOESS) ensemble methods, clustering algorithms, centroid based algorithms, principal component analysis (PCA), singular value decomposition, independent component analysis, k nearest neighbors (kNN), learning vector quantization (LVQ), self-organizing map (SOM), locally weighted learning (LWL), apriori algorithms, eclat algorithms, regularization algorithms, ridge regression, least absolute shrinkage and selection operator (LASSO), elastic net, classification and regression tree (CART), iterative dichotomiser 3(ID3 ), C4.5 and C5.0, chi-squared automatic interaction detection (CHAID), decision stump, M5, conditional decision trees, least-angle regression (LARS), naive bayes, gaussian naïve bayes, multinomial naïve bayes, averaged one-dependence estimators (AODE), bayesian belief network (BBN), bayesian network (BN), k-medians, expectation maximisation (EM), hierarchical clustering, perceptron back-propagation, hopfield network, radial basis function network (RBFN), deep boltzmann machine (DBM), deep belief networks (DBN), convolutional neural network (CNN), stacked auto-encoders, principal component regression (PCR), partial least squares regression (PLSR), sammon mapping, multidimensional scaling (MDS), projection pursuit, linear discriminant analysis (LDA), mixture discriminant analysis (MDA), quadratic discriminant analysis (QDA), flexible discriminant analysis (FDA), bootstrapped aggregation (bagging), adaboost, stacked generalization (blending), gradient boosting machines (GBM), gradient boosted regression trees (GBRT), random forest, or even algorithms yet to be invented.

In a preferred embodiment, the system may monitor location data 430B and safety data 430C of a user 405 and processes said data using a machine learning technique to determine potential safety risks a user may be experiencing during outdoor recreation activities. For instance, the system may obtain GPS coordinates and movement patterns from the GPS device 407 and process it using pattern recognition algorithms to discern when a user 405 may be lost, injured, or in distress based on irregular movement patterns or prolonged stationary periods. The system may then use semi-supervised learning to assess the severity of a potential emergency situation. In some preferred embodiments, the system may use semi-supervised learning to create an appropriate emergency response protocol based on the determined risk level. In one preferred embodiment, the system may continuously monitor location data 430B of a user 405 who is determined to be in a potentially dangerous situation and use semi-supervised learning to adjust the emergency response protocol based on changes in said location data over time. In one preferred embodiment, the system may use machine learning techniques to assist emergency responders with locating and assisting users in distress. For instance, a user 405 having missed multiple check-ins from the check-in timer 504 may trigger the system to analyze location data 430B and environmental conditions via decision tree, supervised learning in order to help emergency responders determine the most likely location and appropriate rescue approach. This information may be provided to emergency responders via safety alerts 409 transmitted as computer readable signals to computing devices.

In a preferred embodiment, the system may monitor location data 430B and safety data 430C of the user 405 and make safety-related recommendations for outdoor recreation activities based on said data. For instance, the system may be operably connected to weather monitoring services and environmental sensors configured to measure conditions such as temperature, wind speed, and precipitation in outdoor recreation areas. Based on current and predicted weather conditions, the system may use unsupervised learning to make route recommendations designed to prevent users from encountering dangerous weather conditions or terrain hazards. In some preferred embodiments, location data 430B collected and processed by the system may be monitored using a machine learning technique to determine when the user 405 may be experiencing an emergency situation and subsequently activate the SOS button 1203 functionality to alert nearby hunters and emergency contacts. For instance, GPS tracking data and check-in timer 504 violations may be analyzed by the system to detect patterns indicating distress. The system may monitor the location data 430B and automatically trigger emergency protocols should it be determined that the user 405 is experiencing a safety emergency. Additionally, the system may alert emergency services of the user's geolocation and transmit safety data 430C indicating the nature of the outdoor recreation emergency when the location data so indicates.

In some preferred embodiments, the system 400 monitors the safety compliance and boundary adherence of a user 405 during outdoor recreation activities. In a preferred embodiment, this function is applied to ensure users remain within approved hunting areas and comply with established safety protocols. In another preferred embodiment, this function is applied to monitor users who are operating in restricted or regulated outdoor recreation zones. In embodiments where this function is applied for regulatory compliance, it is preferred that the system 400 contact appropriate authorities if the user 405 enters restricted areas or violates established safety boundaries without proper authorization. The boundary monitoring may comprise GPS tracking through the GPS device 407, customizable boundary areas created by dropping pins along boundary lines, or other means of assessing location compliance. In yet another preferred embodiment, the system 400 does not apply this function for regulatory enforcement, but as a safety tool for users who wish to ensure they remain within designated safe areas during their outdoor recreation activities. Continuous monitoring by the system 400 in such an embodiment allows real-time assessments that take into account changes in user location and proximity to other hunters that may alter safety considerations.

In a preferred embodiment, the system 400 may use more than one machine learning technique to monitor safety data 430C and location data 430B of a user 405. For instance, the system 400 comprising GPS tracking capabilities may use a combination of pattern recognition and reinforcement learning to discern additional safety risks, such as rapid movement toward dangerous terrain, prolonged stationary periods, or erratic movement patterns, in addition to explicit emergency signals from the user. If the system 400 determines that a user 405 exhibits movement patterns indicating potential distress not explicitly communicated by the user, the system 400 may add those risk factors to an assessment before determining the appropriate safety response. In another preferred embodiment, the system 400 may actively monitor a user's location patterns and check-in compliance to determine if a user is becoming lost or disoriented during outdoor recreation activities. For instance, the system 400 comprising GPS device 407 may use a combination of geospatial analysis and deep learning to discern location patterns of a user 405 while engaged in hunting, hiking, or fishing activities. Should the system determine that a user is exhibiting movement patterns below a safety threshold, the system may recommend that the user activate the live button 1202 for enhanced location sharing or return to a designated safe area. In another preferred embodiment, should the system determine that a user is exhibiting concerning location patterns, the system may automatically activate proximity alerts to notify nearby users of potential safety concerns. In yet another preferred embodiment, the system 400 comprising GPS tracking may use a combination of pattern recognition, geospatial analysis, and deep learning to identify the onset of an emergency situation based on location data. Should the system determine that the user is experiencing an emergency, the system may automatically activate the SOS button 1203 functionality.

In a preferred embodiment, the machine learning techniques comprise instructions configured to create a trained machine learning techniques from at least some training data and according to an implementation of the machine learning techniques, wherein the training data serves as a baseline dataset that may act as the foundational data of the machine learning techniques for outdoor recreation safety analysis. The instructions of the machine learning techniques dictate how the machine learning techniques gain knowledge from the various data sources of the system including user data 430A, location data 430B, safety data 430C, and image data 430D, and may comprise various types of programable instructions that include, but are not limited to, local commands, remote commands, executable files, protocol commands, selected commands, or any combination thereof. The instructions of the machine learning techniques may vary widely, depending on a desired implementation for outdoor recreation safety monitoring. In a preferred embodiment, instructions may include streamed-lined instructions that instruct the machine learning techniques on how to train the system for safety pattern recognition, possibly in the form of a script (e.g., Python, Ruby, JavaScript, etc.). In another preferred embodiment, the instructions may include data filters or data selection criteria that define requirements for desired results sets created from the various data of the system as well as which machine learning algorithm is to be used for analyzing outdoor recreation safety patterns.

Training of the machine learning techniques may be supervised, semi-supervised, or unsupervised. In some preferred embodiments, the machine learning systems may use geospatial analysis and pattern recognition to analyze data (e.g., location data 430B, safety data 430C, etc.) that may be used to train the machine learning techniques for outdoor recreation safety monitoring. For instance, the system may use geospatial analysis and deep learning to ascertain baseline movement patterns of a user 405 during normal outdoor recreation activities, which may be used by the system to determine when a user may be experiencing distress or emergency situations. Training of the machine learning techniques may result in baseline machine learning techniques that may serve as AI techniques for performing the various safety monitoring functions of the system in the manners described herein. Baseline machine learning techniques may further be configured to act as passive models or active models. A passive model may be described as a final, completed machine learning model that uses only the baseline data set to establish behavior of the baseline machine learning technique for safety monitoring. An active model may be described as a plasticity machine learning model that is dynamic in that it may be updated using both the baseline dataset and data outside of the baseline data set for enhanced safety analysis.

In a preferred embodiment, the system may use a passive model to allow for a high degree of control as to how the system manages safety alerts and proximity monitoring in the manners described herein. For instance, a passive model may be configured via a private dataset to provide each user 405 of the system with the same safety recommendations and alert thresholds. These recommendations may be made by the system regardless of user data 430A that may indicate that particular users have historically preferred certain safety settings in certain outdoor recreation circumstances. A passive model may be especially useful for users having user profiles 430 with little safety data 430C from which the machine learning techniques may learn from. In some preferred embodiments, the system may be configured to begin as passive models until a threshold amount of safety data 430C has been acquired. Once the threshold amount of safety data 430C has been acquired, the system may cause the machine learning techniques to switch to active models, allowing the system to make safety recommendations to a user 405 that better parallel historical safety preferences of the user. For instance, a system may be configured to make safety radius recommendations to the user 405 based on a passive model for the first 30 times a particular category of safety recommendation is made, wherein the system may also be configured to determine safety actions taken by a user after safety recommendations are made by the system. After the system has made 30 safety recommendations in a particular category of safety recommendation, the machine learning techniques of the system may switch to an active machine model for that particular user and make safety recommendations based on the safety actions taken by the user 405 after recommendations had been made by the system.

In some embodiments, an active machine model may be updated in real-time, daily, weekly, bimonthly, monthly, quarterly, or annually using the various data (e.g., to update model instructions, shifts in time, new/corrected private data sets, user data 430A, location data 430B, safety data 430C, image data 430D, etc.), of the system. In some preferred embodiments, the passive machine model may also be updated as new/updated private data sets become available for outdoor recreation safety analysis. In a preferred embodiment, machine learning techniques comprise metadata that describe the state of the passive/active model with respect to its updates for safety monitoring applications. The metadata may include attributes describing one or more of the following: a version number, date updated, amount of new safety data used for the update, shifts in model parameters, convergence requirements, or other information. Because each user 405 of the system may potentially have a unique machine learning technique associated with their user profile 430 due to the personal nature of safety data 430C associated with each user profile, such information allows for identifying distinct passive/active models within the system that may be separately managed for optimal outdoor recreation safety monitoring.

In an embodiment, user roles 1510, 1530, 1550 may be assigned to a user 405 in a way such that a requesting user 1505, 1525, 1545 may view user profiles 430 containing user data 430A, location data 430B, safety data 430C, and image data 430D via a user interface 411. To access the data within the database 115, a user 405 may make a user request via the user interface 411 to the processor 220. In an embodiment, the processor 220 may grant or deny the request based on the permission level 1500 associated with the requesting user 1505, 1525, 1545. Only users 405 having appropriate user roles 1510, 1530, 1550 or administrator roles 1570 may access the data within the user profiles 430. For instance, as illustrated in FIG. 15, requesting user 1 1505 has permission to view user 1 content 1515 and user 2 content 1535 whereas requesting user 2 1525 only has permission to view user 2 content 1535. Alternatively, user content 1515, 1535, 1555 may be restricted in a way such that a user may only view a limited amount of user content 1515, 1535, 1555. For instance, requesting user 3 1545 may be granted a permission level 1500 that only allows them to view user 3 content 1555 related to their specific interest but not user 3 content 1555 related to the identity of said user 405. In the example illustrated in FIG. 15, an administrator 865 may bestow a new permission level 1500 on users 405 so that it may grant them greater permissions or lesser permissions. For instance, an administrator 865 may bestow a greater permission level 1500 on other users 405 so that they may view user 3's content 1555 and/or any other user's content 1515, 1535, 1555. Therefore, the permission levels 1500 of the system 400 may be assigned to users 405 in various ways without departing from the inventive subject matter described herein.

The subject matter described herein may be embodied in systems, apparati, methods, and/or articles depending on the desired configuration. In particular, the various implementations of the subject matter described herein may be realized in digital electronic circuitry, integrated circuitry, specially designed application-specific integrated circuits (ASICs), computer hardware, firmware, software, and/or combinations thereof. These various implementations may include implementation in one or more computer programs that may be executable and/or interpretable on a programmable system including at least one programmable processor, which may be special or general purpose, coupled to receive data and instructions from, and to transmit data and instructions to, a storage system, and at least one peripheral device.

These computer programs, which may also be referred to as programs, software, applications, software applications, components, or code, may include machine instructions for a programmable processor, and may be implemented in a high-level procedural and/or object-oriented programming language, and/or in assembly machine language. As used herein, the term “non-transitory computer-readable medium” refers to any computer program, product, apparatus, and/or device, such as magnetic discs, optical disks, memory, and Programmable Logic Devices (PLDs), used to provide machine instructions and/or data to a programmable processor, including a non-transitory computer-readable medium that receives machine instructions as a computer-readable signal. The term “computer-readable signal” refers to any signal used to provide machine instructions and/or data to a programmable processor. To provide for interaction with a user, the subject matter described herein may be implemented on a computer having a display device, such as a cathode ray tube (CRD), liquid crystal display (LCD), light emitting display (LED) monitor for displaying information to the user and a keyboard and a pointing device, such as a mouse or a trackball, by which the user may provide input to the computer. Displays may include, but are not limited to, visual, auditory, cutaneous, kinesthetic, olfactory, and gustatory displays, or any combination thereof.

Other kinds of devices may be used to facilitate interaction with a user as well. For instance, feedback provided to the user may be any form of sensory feedback, such as visual feedback, auditory feedback, or tactile feedback; and input from the user may be received in any form including, but not limited to, acoustic, speech, or tactile input. The subject matter described herein may be implemented in a computing system that includes a back-end component, such as a data server, or that includes a middleware component, such as an application server, or that includes a front-end component, such as a client computer having a graphical user interface or a Web browser through which a user may interact with the system described herein, or any combination of such back-end, middleware, or front-end components. The components of the system may be interconnected by any form or medium of digital data communication, such as a communication network. Examples of communication networks may include, but are not limited to, a local area network (“LAN”), a wide area network (“WAN”), metropolitan area networks (“MAN”), and the internet.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For instance, the implementations described above can be directed to various combinations and subcombinations of the disclosed features and/or combinations and subcombinations of several further features disclosed above. In addition, the logic flow depicted in the accompanying figures and/or described herein do not necessarily require the particular order shown, or sequential order, to achieve desirable results. It will be readily understood to those skilled in the art that various other changes in the details, devices, and arrangements of the parts and method stages which have been described and illustrated in order to explain the nature of this inventive subject matter can be made without departing from the principles and scope of the inventive subject matter.

What is claimed is:

1. A system for enhancing safety and communication among hunters in approved hunting areas, comprising:
a global positioning system,
wherein said global positioning system is configured to detect and transmit geospatial data;
a processor operably connected to said global positioning system;
a power supply; and
a non-transitory computer-readable medium coupled to said processor,
wherein said non-transitory computer-readable medium contains instructions stored thereon, which, when executed by said processor, cause said processor to perform operations comprising:
receiving said geospatial data transmitted by said global positioning system;
determining real-time locations of multiple hunters within said approved hunting areas;
establishing a customizable safety radius around each hunter,
wherein said safety radius can be manually set or selected from preinstalled modes tailored to specific firearms;
monitoring when another hunter enters said customizable safety radius; and
sending proximity alerts to both hunters when said safety radius is crossed.

2. The system of claim 1, wherein said safety radius applies to multiple activity modules with color coding, wherein hunting activities are displayed in orange, hiking activities are displayed in blue, and fishing activities are displayed in yellow.

3. The system of claim 1, further comprising additional instructions stored on said non-transitory computer-readable medium, which, when executed by said processor, cause said processor to perform additional operations comprising:
activating a live mode function that displays real-time locations of hunters to other users; and
deactivating said live mode function to make hunters no longer visible to other users.

4. The system of claim 3, wherein said live mode function is activated by holding an action button for three seconds to display a menu box with live and SOS options, and then holding a live button for an additional three seconds.

5. The system of claim 1, further comprising additional instructions stored on said non-transitory computer-readable medium, which, when executed by said processor, cause said processor to perform additional operations comprising:
creating customizable boundary areas by dropping pins along boundary lines;
monitoring when hunters approach said boundary lines within a predetermined distance; and
sending boundary alerts to designated users when said predetermined distance is reached.

6. The system of claim 5, further comprising said additional instructions stored on said non-transitory computer-readable medium, which, when executed by said processor, cause said processor to perform said additional operations comprising:
establishing a monitoring relationship between a primary user and a secondary user;
alerting said primary user when said secondary user crosses said boundary lines; and
notifying said primary user when said secondary user deactivates said monitoring relationship.

7. The system of claim 1, further comprising additional instructions stored on said non-transitory computer-readable medium, which, when executed by said processor, cause said processor to perform additional operations comprising:
receiving animal location data when a user marks an animal sighting on a map;
displaying said animal location data to other nearby users with customizable icons for specific animals; and
providing a comment system for users to add information about said animal sightings.

8. A mobile application system for hunter safety and communication comprising:
a computing device, wherein said computing device is configured to receive geospatial data via a user interface;
a processor operably connected to said computing device;
a power supply; and
a non-transitory computer-readable medium coupled to said processor,
wherein said non-transitory computer-readable medium contains instructions stored thereon, which, when executed by said processor, cause said processor to perform operations comprising:
receiving said geospatial data transmitted by said computing device;
displaying real-time locations of hunters on an interactive map;
providing an emergency alert system accessible via a centrally located action button,
wherein said action button must be held down for 3 seconds to activate a menu with Live and SOS options,
wherein said SOS option sends alerts with GPS coordinates to nearby hunters and predesignated emergency contacts when activated; and
enabling hunters to mark and share animal sighting locations on said interactive map.

9. The mobile application system of claim 8, further comprising additional instructions stored on said non-transitory computer-readable medium, which, when executed by said processor, cause said processor to perform additional operations comprising:
establishing a customizable safety radius around each hunter displayed on said interactive map;
monitoring when hunters enter said customizable safety radius; and
sending proximity alerts to both hunters when said safety radius is crossed.

10. The mobile application system of claim 9, wherein said safety radius can be manually set or selected from preinstalled modes tailored to specific firearms.

11. The mobile application system of claim 8, further comprising additional instructions stored on said non-transitory computer-readable medium, which, when executed by said processor, cause said processor to perform additional operations comprising:
implementing a check-in feature that requires users to confirm their safety at predetermined intervals;
sending notifications to designated monitoring contacts when check-ins are completed; and
automatically triggering said SOS option when check-ins are missed three consecutive times.

12. The mobile application system of claim 8, further comprising additional instructions stored on said non-transitory computer-readable medium, which, when executed by said processor, cause said processor to perform additional operations comprising:
providing group chat functionality for real-time communication between hunters;
enabling sharing of text messages and images through said group chat functionality; and
maintaining a digital logbook for documenting hunting experiences.

13. The mobile application system of claim 12, further comprising said additional instructions stored on said non-transitory computer-readable medium, which, when executed by said processor, cause said processor to perform said additional operations comprising:
allowing users to record location, date, time, and observations in said digital logbook; and
enabling users to share logbook entries with other hunters through said mobile application system.

14. The mobile application system of claim 8, wherein said SOS option causes said action button to blink red when activated and displays said GPS coordinates and safety radius of an emergency user as red to help other users locate said emergency user.

15. A method for managing hunter safety in approved hunting areas comprising steps of:
determining real-time geolocations of multiple hunters using GPS technology;
establishing customizable safety radii around each hunter based on firearm specifications;
monitoring proximity between hunters within said approved hunting areas;
sending automated proximity alerts when hunters enter each other's safety radii;
providing emergency response capabilities through an SOS system that transmits location data to nearby hunters and emergency contacts; and
facilitating collaborative hunting through shared animal location markers on an interactive map interface.

16. The method of claim 15, wherein said customizable safety radii are selected from preinstalled modes tailored to specific firearms.

17. The method of claim 15, further comprising steps of:
creating customizable boundary areas by dropping pins along boundary lines;
monitoring when hunters approach said boundary lines within a predetermined distance; and
sending boundary alerts to designated users when said predetermined distance is reached.

18. The method of claim 17, further comprising steps of:
establishing a monitoring relationship between a primary user and a secondary user;
alerting said primary user when said secondary user crosses said boundary lines; and
notifying said primary user when said secondary user deactivates said monitoring relationship.

19. The method of claim 15, further comprising steps of:
implementing a check-in feature that requires hunters to confirm their safety at predetermined intervals;
sending notifications to designated monitoring contacts when check-ins are completed; and
automatically triggering said SOS system when check-ins are missed three consecutive times.

20. The method of claim 19, further comprising steps of:
providing group chat functionality for real-time communication between hunters;
enabling sharing of text messages and images through said group chat functionality; and
maintaining a digital logbook for documenting hunting experiences with location, date, time, and observations.
